(19) United States
(12) Patent Application Publication
(10) Pub. No.: US 2026/0133933 A1
(43) Pub. Date: May 14, 2026

(54) ARRAY PROCESSING ENTITY ARRAY PLACEMENT AND ROUTING

(71) Applicant: Mobileye Vision Technologies Ltd., Jerusalem (IL)

(72) Inventors: Koby Yacob TAYREE, Midrakh Oz (IL); Amjad ABUD, Kfar Yasif (IL); Dror LIVNE, Herzliya (IL); Arie TAL, Zikhron Ya'akov (IL)

(21) Appl. No.: 19/120,604

(22) PCT Filed: Oct. 13, 2023
(86) PCT No.: PCT/IB2023/000601

§ 371 Date: Apr. 11, 2025

Related U.S. Application Data
(60) Provisional application No. 63/415,945, filed on Oct. 13, 2022.

(51) Int. Cl. G06F 15/80

(52) U.S. Cl. CPC G06F 15/80

(57) ABSTRACT

A method for automatically placing and routing processing elements (PEs), where each PE has a limited connectivity to its neighbors. The method may obtain placement primitive (PP) location window information, the location window information defining possible locations of a group of PPs within a coarse-grained reconfigurable array (CGRA). The method may obtain hardware constraints regarding the array of PEs, the hardware constraints comprise local connectivity constraints and remote connectivity constraints. The method may receive a computation graph (CG) that represents mathematical expressions to be calculated by the array of PEs. The method may determine a location of the PEs of the array of PEs based on the CG, the PP location window information, and hardware constraints.

### PRIORITY

This application claims the benefit of priority to U.S. Provisional Patent Application Ser. No. 63/415,945, filed Oct. 13, 2022, which is incorporated by reference herein in its entirety.

### BACKGROUND

The need to increase the throughput and performance of computerized systems has driven the industry to use arrays of processing entities. An array of processing entities may be designed to fulfill a computation graph. A placement and routing process for determining the locations of the processing entities of the array and the connectivity between the processing entities is time consuming and takes many hours to complete. There is a growing need to provide an efficient, cost effective and scalable solution for placement and routing of processing entities of an array of processing entities.

### SUMMARY

There may be provided a method, non-transitory computer readable medium for placement and routing of processing entities of an array of processing entities.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the FIGs. of the accompanying drawings in which:

FIG. 1 illustrates an example of an array of processing entities;

FIG. 2 illustrates an example of a computation graph;

FIG. 3 illustrates an example of a balancing step;

FIG. 4 illustrates an example of generating subgraphs;

FIG. 5 illustrates an example of a placement primitive;

FIG. 6 illustrates an example of a placement primitive;

FIG. 7 illustrates an example of allowed hardware implementations of placement primitives and of permutations;

FIG. 8 illustrates an example of a method;

FIG. 9 illustrates an example of a method;

FIG. 10 illustrates an example of a method;

FIG. 11 illustrates an example of a method;

FIG. 12 illustrates an example of a placement primitive and generation of a consumer hash value;

FIG. 13 illustrates an example of a placement primitive and generation of a consumer hash value;

FIG. 14 illustrates an example of a placement primitive and consumer hash values of allowable hardware implementations of the placement primitive;

FIG. 15 illustrates an example of a placement primitive and consumer hash values of allowable hardware implementations of the placement primitive;

FIG. 16 illustrates an example of allowable hardware implementations of a placement primitive and generation of consumer hash values;

FIG. 17 illustrates an example of a placement primitive and producer hash values of allowable hardware implementations of the placement primitive;

FIG. 18 illustrates an example of producer hash values of allowable hardware implementations of a placement primitive;

FIG. 19 illustrates an example of a window, anchors, placement primitives, and two placement iterations;

FIG. 20 illustrates an example of windows and hash values;

FIG. 21 illustrates an example of a placement primitive and full hash values;

FIG. 22 illustrates an example of a method;

FIG. 23 illustrates an example of a method;

FIG. 24 illustrates an array of PEs; and

FIG. 25 illustrates an array of PEs.

### DETAILED DESCRIPTION

In the following detailed description, numerous specific details are set forth in order to provide a thorough understanding of the embodiments of the disclosure. However, it will be understood by those skilled in the art that the present embodiments of the disclosure may be practiced without these specific details. In other instances, well-known methods, procedures, and components have not been described in detail so as not to obscure the present embodiments of the disclosure.

There is provided herein a method to automatically place and route in a matter of mere seconds to very few minutes—in contrary to prior art methods that are more lengthy (for example by a factor that exceeds ×10, ×20, ×30 and even more). This provides a significant reduction (for example by a factor that exceeds ×10, ×20, ×30 and even more) of computational resources, and/or a significant reduction (for example by a factor that exceeds ×10, ×20, ×30 and even more) in memory resources and/or a significant reduction in traffic (for example by a factor that exceeds ×10, ×20, ×30 and even more).

An array such as a coarse-grained Reconfigurable Array (CGRA) of processing elements (PEs) (also referred to as processing entities) can abstractly be viewed as a lattice of Processing Elements (PEs), where each PE have a limited connectivity to its neighbors, a feature referred to as locality constraints.

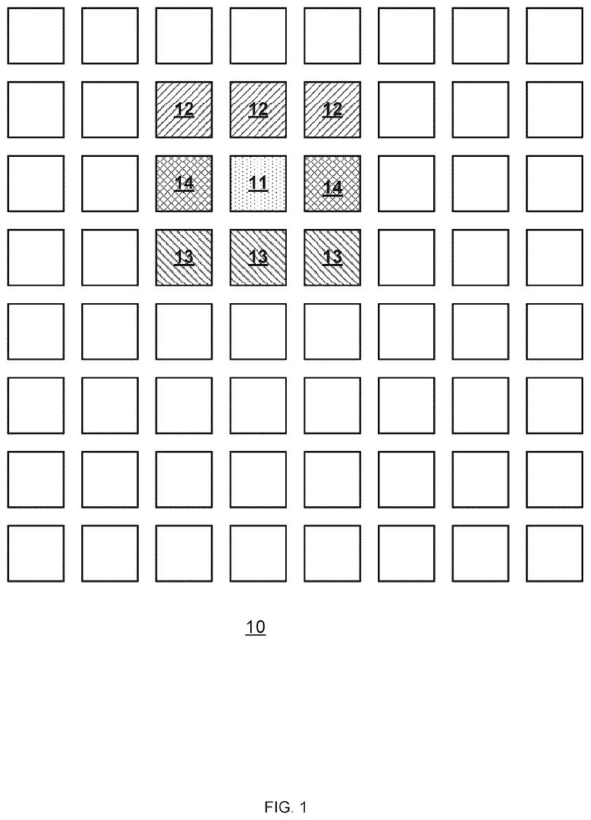

For each PE, there are two kinds of locality constrained neighbors—a set of local data producers—those neighbors PEs which can transmit data to it, and a set of local consumers, defined similarly. See, for example, in FIG. 1—CGRA 10 includes multiple PEs—such as a certain PE 11 has eight neighbors—producers 12, consumers 13 and PEs 14 that are both consumers and producers.

A CGRA realization may allow additional set of shallow connectivity to non-neighbor PEs, which tend to be scarce and insufficient to manifest non-trivial computations.

A computation graph represents inputs programs, where different nodes represent operations and (directed) edges represent producer-to-consumer relations.

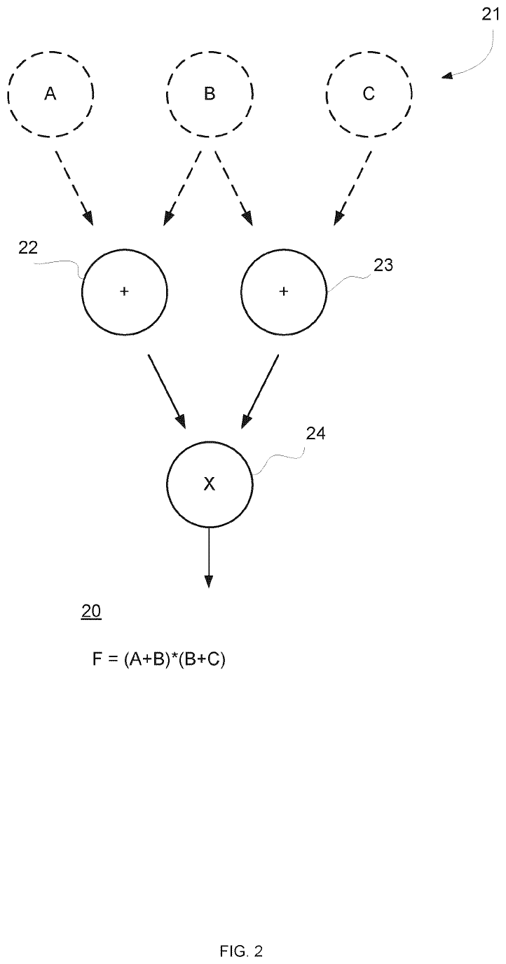

In this computation graph a PE is represented by a node (a solid circle). See, for example, FIG. 2 that illustrates a computation graph 20 that represents a function F=(A+B)*(B+C), dashed circles 21 illustrate the provision of variables A, B and C to two adders (nodes 22 and 23) which are two PEs that perform additions, having their outputs fed to a multiplier (node 24).

Local connectivity constraints are modeled as edges between PE nodes.

A CGRA may be required to implement the computation graph.

The computation graph may be balanced, and then is segmented to subgraphs.

The division points (links between subgraphs) may be routed to a Benes network (BE).

Each such subgraph is considered an atomic unit which should be placed by local connectivity.

One or more subgraphs should be positioned within a ‘bucket’ or window.

The number and layout of desired buckets may be predefined, while allowing edges (i.e., computational dependencies) to toggle between local or network connections within subgraphs if it is needed to preserve timing validity.

In turn, each bucket is being served into a rapid local placer, named QRAPP (quite rapid affine placement planner), which quickly answers whether local placement is possible (and if so, returns such a placement), or not. As described herein, the entire computational flow may include balancing, relaxation, bucketing, placement, revocation, and routing. QRAPP may be used during the placement phase of this overall computational flow.

Once placement for all buckets is achieved, routing is performed in order to allow both vast expressiveness and efficient and quick routing process.

The computation graph may be balanced, assuming PE to PE connectivity to be local. The balancing may equalize latency between different paths between the same pair of source and target of the computation graph.

Balancing may be followed by a relaxation phase. This may include identifying graph instances with topologies that are computationally complex, topologies that are infeasible for the target hardware, or topologies that may pose a strain to bucketing or placement activities. Once these graph instances are identified, relaxation includes reallocating these graph instances into subgraphs. In an example, if the identification phase identified a graph instance node with six sub-nodes, and the reallocation phase may include cloning the node and moving three of the six sub-nodes to the cloned node. This relaxation phase may provide improved processing throughput, such as by reducing overall compilation time.

For each bucket, the method may repeat, for each subgraph that should be located within the bucket: (a) trying local placement (by invoking QRAPP), (b) if failed, try relaxing the local constraints by ‘removing’ local edges (turn to network) from the bucket's subgraphs, while preserving timing correctness, or (c) if failed try another buckets layout.

QRAPP may identify special predefined set of subgraphs in its input, breaking into the combination of them, and utilizing pattern tables for each such special subgraph in order to overcome the complexity of realizing what set of local connections are allowed, and how to connect several such connections.

Once all buckets been placed, a revocation phase may be used to reduce or minimize the amount of remote edges induced by bucketing. This may include examining both remote edges within each bucket (e.g., local edges due to proximity) and across bucket edges (e.g., based on bucket proximity). Once examined, this revocation may include shuffling buckets across the PE grid to improve or maximize cross-edge opportunities. This determination of cross-edge opportunities may be solved using one or more optimization solutions, such as of constraint satisfaction problem (CSP) optimization, integer linear programming (ILP) optimization, or propositional satisfiability problem (SAT) optimization. Revocation may also include ensuring timing validity remains intact following this shuffling, and reversing any shuffling if timing validity does not remain intact.

This use of revocation provides various advantages. Because remote edges tend to carry increased latency (vs local edges), the revocation process of reducing or minimizing remote edges may reduce or minimize computation latency. Additionally, removing remote edges during revocation may improve the feasibility of routing, such as by increasing the likelihood that the induced network transformation may be both feasible and rapidly solved.

Once all buckets been placed and revocation completed, a Benes network (BN) routing scheme may be applied, which may yield a rich class transformation fully and trivially (efficiently) routinely by the BN, and can be applied to sub transformations of the overall BN transformation as well (the method may declare routability by scanning disjoint sub-transformations parts of the overall transformation).

The routing may include using freedom ranks embedded into the array of PEs regarding the network (transformation) manifestation, to shape it as a BN-compliant transformation, and conclude routing.

In another example, the method may receive some input transformation and perform such relaxations upon it to make it ‘as much’ routable as possible.

### Balancing

The computation graph may be balanced—to provide equal latency to different paths between the same source and the same target.

For a node in the computation graph (the node is a PE) to operate correctly, its inputs should arrive on the same cycle.

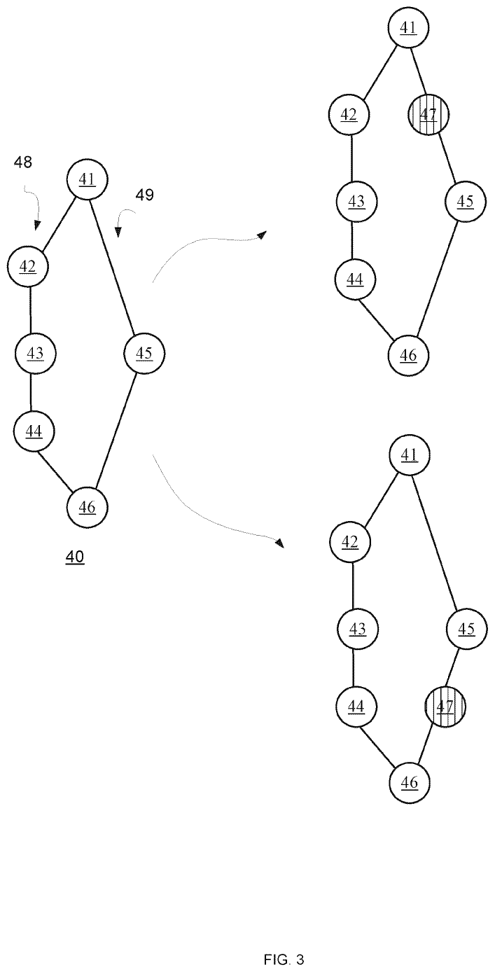

As an example, consider the following subgraph 40 of FIG. 3.

Subgraph 40 includes source node 41 and target node 46. There are two paths between source node 41 and target node 46.

If each edge contributes no delay (in cycles), each PE contributes minimal delay of 3 cycles, and may additionally further delay data for 5 more cycles.

Under this assumption, the left path 48 (including nodes 42, 43 and 44) has a (minimal) delay of 9 cycles, while the right path 49 (including node 45) has a (maximal) delay of 8 cycles.

A potential balancing will include adding a delay of 1 to the right path—for example adding a copy node 47—either between nodes 41 and 45—or between nodes 45 and 46. By doing so, we've increased the minimal latency of the right path to be 6 cycles, and since each node may contribute additional delay of up-to 5 cycles—we can, for example, use 3 delay cycles from copy node 47, and we have both right and left paths latency equalize at 9 cycles.

The same process should be applied to other paths of the computation graph.

The problem is considered a non-polynomial (NP) problem, and it may be solved using ILP (Integer Linear Programming) which is the NP derivation of LP (Linear Programming), where the challenge to be solved is restructured as a set of linear equations, i.e., equations of the form: Ax+By+Cz . . . =R, where A, B, C . . . are constant coefficients, and x, y, z, . . . are variables which their values are sought.

The balancing under the assumption that any edge between two DPUs is a local edge, i.e., an edge with Zero additional delay.

Even if the assumption of zero delay is faulty—this assumption can be remedied during the ‘bucketing’ phase, where the assumption may be violated it in order to make the computation graph more feasible for the sake of placement.

### Bucketing

The balanced computation graph may be segmented (e.g., bucketed) into disjointed subgraphs, to expedite placement (placing N subgraphs of maximal size M in serial is far less complex then placing a single graph of a maximal size N×M), N and M are positive integers.

The subgraphs were originally linked by edges, and the segmenting includes replacing these edges by remote connectivity links—with no hardware routing constraints—for example by replacing the links by remote connectivity links—for example by network or interconnect—for example ports of a Benes network.

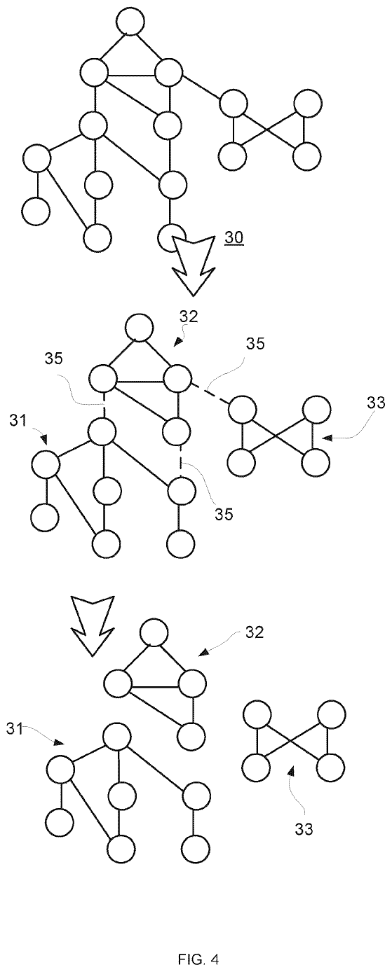

See, for example, the computation graph 30 of FIG. 4. The computation graph 30 includes subgraphs 31, 32 and 33 linked by edges 35. The edges 35 are treated as remote connectivity links, and are “removed” to provide the disjoint subgraphs.

The replacement should be done by considering remote connectivity constraints such as increased latency and/or limited remote link capacity of bandwidth per each PE (for example up to a certain number of bits per cycle—for example up to 32, 64, 128 and the like bits per cycle). In an example, the replacement may be determined based on a reduction or minimization of latency or remote link capacity, such as to improve processing efficiency and bandwidth. The increased use of remote connectivity constraints may reduce the number of placement constraints, which may increase the placement phase and increase the latency of the execution graph. In an example, the number of remote connectivity constraints may be selected to improve or maximize the placement phase speed while improving or minimizing the latency of the execution graph, such as using one or more optimization solutions.

It may also be beneficial not to add additional copy nodes (such as node 47 of FIG. 3—that just copy their input to their output while adding a delay) due to the segmenting.

Accordingly—the starting point of this problem is that (a) the balanced computation graph (before segmenting) was balanced (under the assumption that all local point to point PEs connections impose a placement constraint (for example—local edge has a zero delay), (b) the segmented computation graph should be segmented to N disjoint subgraphs, as far as placement is to be concerned, each with a maximal size of M, (c) the remote connectivity constraints should not be violated.

The problem may be solved by constructing a set of linear integer equations, i.e., an ILP form, which may dictate the following:
a. Each node (HC) may be associated with any subgraph from the N available subgraphs.
b. If two nodes which connected by an edge are associated with different subgraphs, their connecting edge should be a Far edge.
c. If an edge can be marked as far edge, even if its two endpoint nodes are located on the same subgraph, it is allowed if needed for achieving feasible Balancing.
d. Balancing correctness should be kept.
e. Each single node may not exceed the PE limitation of incoming Far connections per node.
f. Each bucketed subgraph may not exceed a maximal size of M.

These statements model a valid state, and this valid state enables the linear integer equations to be solved.

Once a valid ILP solution is found—it provides a valid segmentation.

The valid segmentation may be referred to as a bucket, and various groups of placement primitives may be fitted to one or more of these buckets.

Multiple placement primitives may be determined in advance—for example to include all or some of the possible placement primitives given various shapes of computation graphs and/or shapes of computation subgraphs.

Evaluated placement primitives may be determined based on the computation graph.

Placement primitives represent local connectivity constraints.

As local connectivity constraints tend to be limited, the variety of evaluated placement primitives related to the computation graph is expected to be proportionally limited as well.

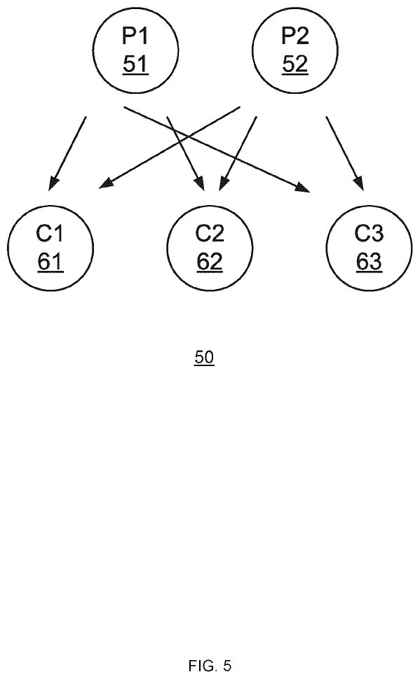

An example of a placement primitive is a fully connected (bicliques) placement primitive. Each node (producer) on one partition, is connected (over local connections) to all the nodes (consumers) on the other partition. See, for example placement primitive 50 of FIG. 5—that includes two producers (P1 51 and P2 52) and three consumers (C1 61, C2 62 and C3 63) that are fully connected.

Note that the above placement primitive can also be viewed as a combination of two 1 to 3 placement primitives, or six 1 to 1 placement primitives, etc.

A fully connected placement primitive may encompass many (possibly all, within a context) locality constraints, it is easily collectable from the computation graph, and it does not represent complex structures (mainly or only local connections)—so the hardware matching structural patterns are expected to be reasonable (a subset of its possible local connections embedment).

Since nontrivial bicliques require the presence of edges, and since computation graphs can also contain isolated nodes, fully connected (bicliques) placement primitives are selected.

It should be noted that placement primitives also allow to determine some infeasibility cases (for example may help in determine local connectivity which is required by the computation graph but infeasible on local connection only) at this preliminary step.

The method may examine only maximal placement primitives, where the maximal placement primitives may be defined as placement primitives whose dimensions may not exceed M (the maximal size of the sub-graph) or may not exceed a location window in which the placement primitives should be placed. The location window may define possible locations for a group of placement primitives, and different location windows may be used for different groups of placement primitives. The location window dimensions may equal the bucket dimensions, or may be smaller than the bucket dimensions.

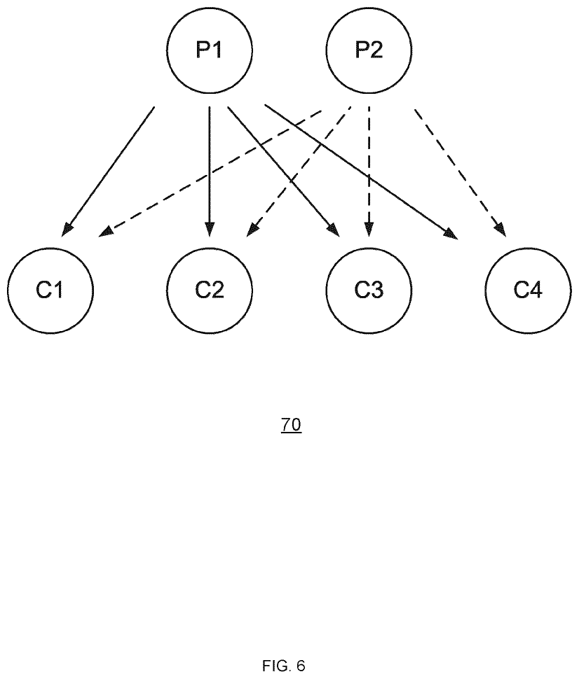

Regarding the maximal placement primitive—and referring to FIG. 5—the 2 producer to 3 consumer placement primitive 50 includes smaller placement primitives—for example single producer to three consumes, a single producer to two consumers, a producer to a consumer. The upper limit to the size of the maximal placement primitive is set by the size of the window. For example—a window of 5×5 may support a larger placement primitive—such as 2 producers and four consumers placement primitive (see placement primitive 70 of FIG. 6), a 4 producers and 5 consumers placement primitive, and the like.

Using maximal placement primitives reduces the computational resources required to perform the filling—as there are fewer maximal placement primitives than smaller placement primitive, providing fewer overall options to traverse. Furthermore—using maximal placement primitives tend to have less structural alternatives (i.e., HW allowed patterns).

The maximal placement primitives are defined per computation graph.

The evaluated placement primitives should cover all the computation graph.

In addition, for each window, the process computes valid locations of one or more placement primitives within the window.

PEs may differ from each other by functionality and their possible valid positions—and the filling is also responsive to these constraints. For example—there may be general purpose PEs, some PEs having trigonometry calculations, some other PEs having integer division capabilities, some fixed-point PEs, some floating-point PEs, and the like. The possible valid location may be driven from a required accessibility of PEs of some functionality to other PEs that do not have that functionality.

The filling process proceeds to perform placement primitive based calculations.

Given hardware locality constraints—each placement primitive is associated with a matching table (or other type of information) of allowed hardware implementations. For example—referring the placement primitive 70 of FIG. 6 that includes two producers (P1 and P2) and four consumers (C1, C2, C3, C4).

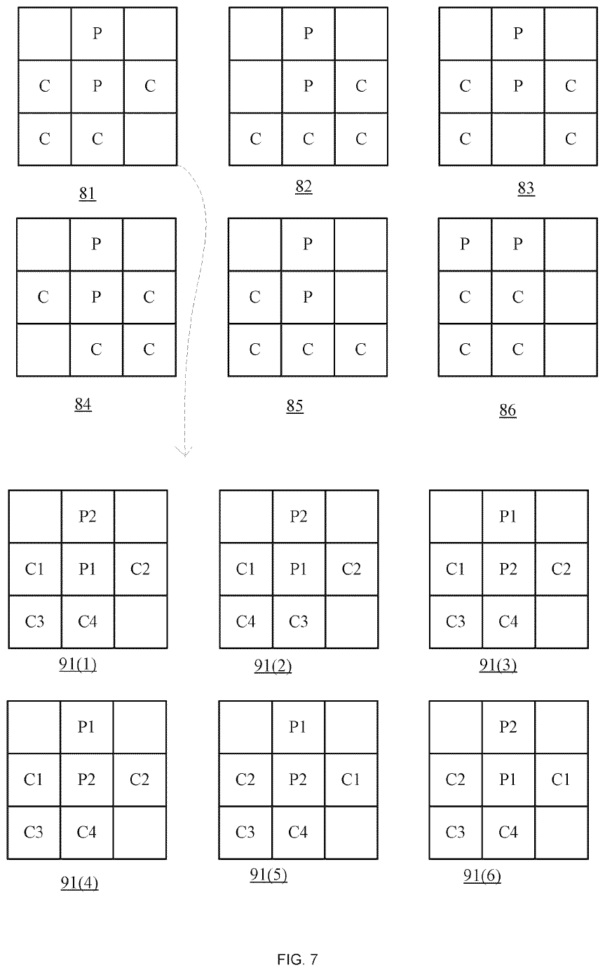

FIG. 7 illustrates six allowed hardware implementations 81-86 of placement primitive 70, and illustrated six permutations 91(1)-91(6) of the first allowed hardware implementation 81.

The allowed hardware implementations may be represented by one or more tables. Such tables are pre-generated—and may not be computation graph dependent. The tables may be generated once and/or off-line and/or during an initialization step—for example as part of a creation and/or build of a placement tool, and may be derived immediately from local connectivity constraints. The tables may store possible allowed hardware implementations for each placement primitive, assuming an empty window, thus, it can and should be calculated regardless of the computation subgraph and/or in off-line. By avoiding the use of the computation subgraph, the hardware implementations for each placement primitive may be determined more efficiently. Avoiding the use of the CG in determining the PP locations provides various advantages. Using these predefined tables saves a significant amount of compute cycles wasted, particularly over solutions that include calculating allowed hardware implementations during the placement process. The tables may be stored in a compressed (e.g., compact) form. In an example, this may include representing one or more of the tables by one or more hash values. This compressed or compact storage format may include offline generation of a table, which allows more complex methods that may be used to generate the compressed form of these tables.

In relation to a placement primitive, the allowed hardware implementations of the placement primitive may be hashed (to provide a hashing table that is accessed using a hash value), and sorted (in the hashing table) to allow fast and simple access. For example—when searching to place a placement primitive within a window that I already populated with another placement primitive—instead of evaluating all possible allowed hardware implementations—the search may be limited to allowed hardware implementations that have a hash value that equals (or is at least similar) to the hash value of already placed anchors.

When hashing, a current placement primitive state may be hashed using the same indexing function to realize in an early stage whether the current placement primitive state can be placed into a window that is already partially populated.

The hashing can be producers based, and/or consumer based and/or vacant placed based, and the like.

The hashing may represent a canonical format (which may be an aligned format of the placement primitive) of a placement primitive or may represent a non-canonical format of the placement primitive. The latter also provides an indication about the location of the placement primitive (or nodes of the placement primitives) within the window.

The hash values may be used to determine, for example by applying logic functions (for example NAND, AND, and the like) on various hash values, whether a current placement primitive may be positioned within an already partially populated window—while saving computational resources—as the hash values may provide a compact representation of the multi-dimension allowed hardware implementations.

Using hashing and the applying the logic functions allows to easily determine the amount and position and semantics of anchors (placed nodes of already positioned placement primitives).

Using hashing and the applying the logic functions may provide a balanced tradeoff between fast and accurate access to allowed hardware implementations and, and the amount of information required to store the hash values.

A hash value of an allowed hardware implementation may be generated by scanning the nodes of the allowed hardware implementations—starting, for example from a predefined element of a window and ending at the end of the allowed hardware implementation. Alternatively, the scanning may start at the end of the allowed hardware implementation and may end at a predefined point.

An example of a hashing pseudo-code is provided below:

```
for (auto point : points) {
    unsigned adj_row = point.first − min_row;
    unsigned adj_col = point.second − min_col;
    bitmap_key |= 1 << (adj_row*COL_DIM + adj_col);
    unsigned adj_row2 = point.first − p_min_row;
    unsigned adj_col2 = point.second − p_min_col;
    key |= 1 << (adj_row2*COL_DIM + adj_col2);
  }
```

### Wherein:

points: a list of nodes in the primitive, represented by (row, col) coordinates, could be producers or consumers or any other sub-group of nodes.
min_row/min_col: the minimum row/col among the coordinates of nodes in ‘points’ list
p_min_col/p_min_row: the minimum row/col among the coordinates of all nodes in the primitive
COL_DIM: is the size of column dimension.

Next, a placement primitive placement plan is constructed.

The overall orientation is to minimize freedom ranks for each subsequent placement primitive being placed, mainly by following nodes/edges overlaps.

Then the plan is traversed by order, and any redundant placement primitive (a placement primitive which all its nodes [singleton] and edges where already embedded by previous placement primitives) is removed.

Each such computation may have a various overhead, and it may aggregate to a hefty toll. By using static planning, the dynamic selection is not needed—which was found to result in superb running time.

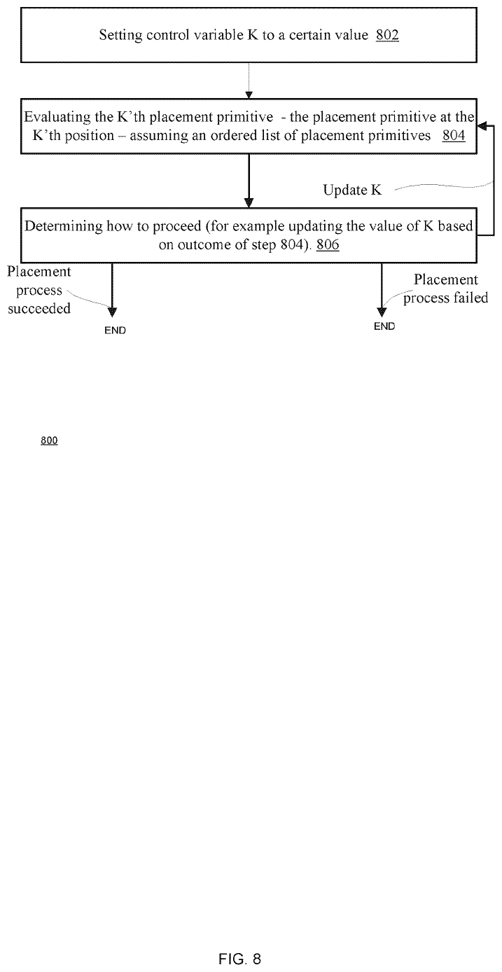

FIG. 8 illustrates an example of a placement process 800.

The placement process may start by setting (802) control variable K to a certain value—for example 0.

The placement process is followed by evaluating (804) the K'th placement primitive—the placement primitive at the K'th position—assuming an ordered list of placement primitives.

Step 804 may include checking if the K'th placement primitive has anchors (i.e., already placed nodes in the window)—if so—placing the K'th placement primitive so that a node of the K'th placement primitive is placed on the anchor if not then the process may use the placement order of the placement primitives. Both anchors, in case there are such, and node to place first (bootstrap) in case there is no anchors, are pre-determined during the planning phase. In addition, hashing can be used to represent the anchors.

Step 804 may be followed by step 806 of determine how to proceed—for example update the value of K and jump to step 804, end the process if the process succeeded or failed.

Steps 804 and 806 may be repeated multiple times—during multiple iterations—and choosing the location of from valid locations possible (after intersecting it with the currently vacant frame locations). This may also include looking for an allowed hardware implementations matching the current anchors relative positions, which is also viable past intersecting with current vacant locations on our frame.

Assuming that there are no anchors—the relevant window of the placement frame is constructed and intersected against a candidate pattern.

If no pattern passes intersection, a RETREAT action may be performed to retreat to K−1, otherwise commit to the pattern and permute nodes upon it, and increase the value of K, resulting in an ADVANCE action.

In case of an ADVANCE action, go to step 804.

In case of a RETREAT action, a naïve flow for RETREAT is to permute until no more permutations are available, then advance to the next pattern.

The retreat may include realizing intersection set between current placement primitive nodes, which were added by it to the frame (denoted A), and the overall set of nodes from the placement primitive we've retreated from. If they intersect—further permute A, if possible, and re-advance to K+1.

If no more permutations are available—advance to the next pattern. If no more patterns are available, retreat to K−1.

If A is empty—advance to the next pattern, permute, and proceed to K+1.

If retreated all the way to K=−1—declare infeasibility.

If advanced up until K=size(plan_list), (plan_list is a number of PPs in the placement plan) then we have a valid solution—terminate successfully.

It should be noted that the inferring of A can and should be done (once) statically already on planning.

Regarding permutations—it is important to distinguish between logical groups within patterns—for the example of bicliques—two disjoint sets, each with its semantics—producers and consumers—a producer may only permute with another producer, a consumer may only permute with another consumer. In general, each node may permute only with other nodes of its class.

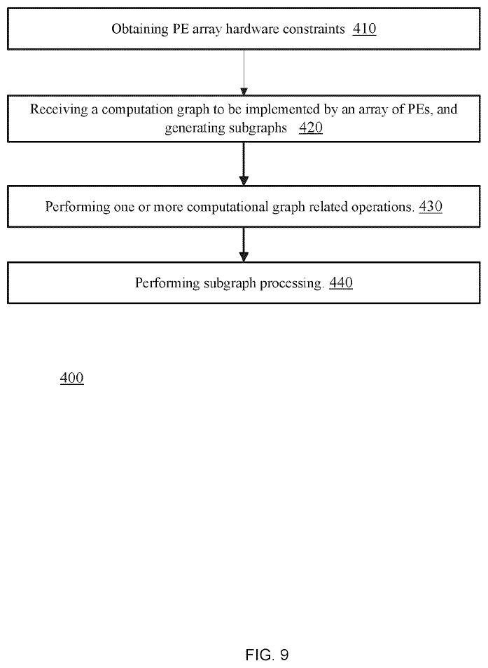

FIG. 9 illustrates an example of method 400.

Method 400 may include initialization step 410 of obtaining PE array hardware constraints.

Step 410 may include obtaining placement primitives and allowed hardware implementations of the placement primitives.

Method 400 may also include step 420 of receiving a computation graph to be implemented by an array of PEs.

Step 420 may be followed by step 430 of performing one or more computation graph related operations. The computation graph related operations include generating subgraphs.

The generating of the subgraphs may be preceded by balancing the computation graph. The generating of the subgraphs may include segmenting the graph to subgraphs while maintaining the balance, replacing links that previously linked subgraphs by remote connectivity, while taking into account remote connectivity constraints. This may involve using ILP.

Step 430 may include ordering placement primitives that are relevant to the computation graph.

The order of the primitives may be determined in any manner—for example it may be determined based on at least one of the following constraints:
a. Number of placed nodes.
b. If there are no placed nodes, calculate bootstrap score.
c. Reduce number of permutations.
d. Maximum number of reachable nodes from consumers.
e. Prefer fully placed producers/consumers.
f. Minimum primitive size.
g. Maximum placed producers.
h. Maximum placed consumers.

A bootstrap score is assigned when there are no anchors—a bootstrap score of a node is higher when (a) there is few reachable from nodes, and/or (b) there is many reachable nodes. For each primitive, the bootstrap score is the same as the higher node bootstrap score. Also, such node is the bootstrap of that primitive.

Once the order is set—the placement process may ignore placement primitives that have all their nodes appear in previous placement primitives and have all their edges appear in previous placement primitives.

The placement process may also ignore locations within a window that are not feasible. For example—a source node that is connected to three or more destination nodes cannot be placed in a corner of a window, assuming that the node at the corner of the window is limited to be connected to two or less nodes.

Step 430 may be followed by step 440 of performing subgraph processing. Step 440 may include trying to fit location primitives that represent parts of the subgraphs to windows.

Per window—step 440 may include:
a. Calculating the valid location for each node.
b. Trying to place a placement primitive.
   i. If succeed, proceed to next placement primitive.
   ii. If fail, try next placement option for that placement primitive.
   iii. If all options fail, retreat to previous placement primitive.
   iv. Succeed if all placement primitives representing the subgraph are placed, otherwise fail.

Given a placement primitive to place.
a. If it has no placed nodes, place the bootstrap node.
b. Try all vacant valid locations for that bootstrap node.
c. Based on placed nodes and vacant places inside the window, try all valid solutions for that placement primitive.
d. If there are more than one unplaced producer/consumer.
e. Try all permutation options, for each one of the picked solutions.

The planning stage is static, that is, once the order is set, it is fixed and will not change it during placement stage.

The planning can be done based only on the given graph, regardless of the hardware available elements, i.e., locations. In such cases, the planning is executed once for all given group of locations (i.e., various placement frames).

Another approach would be to execute the planning for each group of locations, if it can help pick a better ordering of the placement primitives based on the additional information, such as the valid locations per node.

Planning aims to reduce options exploration, such that if there is a failure on the sub tree of tries, try FIG. it as soon as possible.

For example, prioritize placement primitives with anchor first, and placement primitives with fewer permutations over placement primitives with higher permutations, etc.

A placement planner might fail to place a given graph into a given group of locations, thus, it is expected in such a case to try to place the graph on different groups of locations.

Each group can be presented as a matrix, where some entries are invalid.

Entries can be invalidated by user, because it is occupied by other computation graph, or because its corresponding hardware node does not implement an operation represented by the graph node (for which this valid location matrix is generated).

For each node, a valid location matrix is created, where it can be used to determine if a location is valid or invalid for such node.

In addition to the invalid locations passed by the user, more invalid locations can be determined based on the graph and the hardware constraints, for example, node degree can affect if the node can be placed in a matrix corner or not.

Such a valid location matrix can be used to perform a RETREAT action earlier and prevent exploring such failure options, only to recognize after a few placement primitives that there is no solution in such directions.

Hashing is used to index the tables that store the allowed hardware implementations.

For an array of PEs, where placement primitive is considered as a biclique of producer nodes and consumers nodes, hashing can be done considering producers only while ignoring consumers, or the other way around, i.e., considering consumers while ignoring producers, or on both group of nodes at once. Alternatively, the hashing may consider producers, consumers and vacant nodes.

For example, a bitmap (or a hexagonal string) can be used to hash a matching pattern based on the located considered nodes inside the pattern, assigning one or more bits per location.

In addition, the hashing may be canonical, to eliminate repeated patterns, with offset from the matching location. To do so, the hashing may not include the starting point of a nonvacant nodes—for example may ignore empty window edges (empty uppermost or lowermost row and/or rightmost or leftmost column).

For example, assuming the matching location is a rectangle, where left columns or top rows are empty, the pattern can be shifted left and up, before calculating the hashing, to produce a canonical hashing. Canonical hashing is a hashing of a canonical format of an allowed hardware implementation. The hashing may be applied to non-canonical formats of the allowed hardware implementation.

Once the canonical hashing is created, the matching pattern list can be reordered based on that hashing. As we can hash using producers only, or consumers only, or a mixture thereof, or a mixture of vacant nodes, producers and consumers.

Since there can be more than one ordering which can be arranged statically and used dynamically based on the available group of nodes to hash, the process may hold only sorted indices list to the original table of matching patterns, rather than hold multiple full matching pattern lists ordered differently.

Hashing is used not only on matching patterns, but may also be used on the subgroup of hardware locations represented, for example, as a matrix or so, to capture the vacant locations.

The hashing can be used to speed up intersection of a matching pattern with vacant locations. The unique technique is to pre-calculate a dynamic hashing of vacant locations that allows re-generating the hashing for a few matrixes nearby the anchor nodes, using only simple arithmetic operations, such as shifts and masks.

This can reduce the calculating of the hashing per each matching pattern, and thus enhance matching pattern intersect with vacant locations.

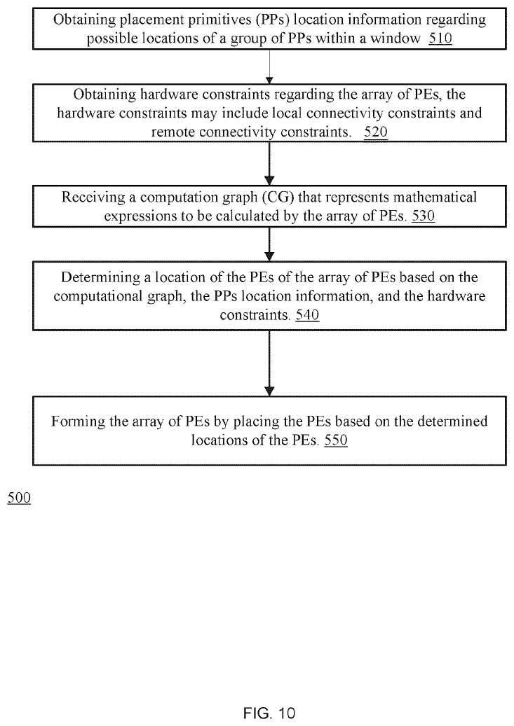

FIG. 10 illustrates an example of a method 500 for placement and routing of processing entities (PEs) of an array of PEs.

Method 500 may include steps 510 and 520.

Step 510 may include obtaining placement primitives (PPs) location information regarding possible locations of a group of PPs within a window.

Step 520 may include obtaining hardware constraints regarding the array of PEs, the hardware constraints may include local connectivity constraints and remote connectivity constraints.

The local connectivity constraints may define point-to-point connections between the PEs, wherein a point-to-point connection connects a PE to neighbor of the PE. Local may refer to a connection of a length below a certain length threshold (for example a distance between adjacent PEs). In an example, a determination of a location of PEs may be based on a reduction or minimization of local connection lengths, such as to improve processing efficiency and bandwidth. Placement primitives may provide various advantages, such as improving or maximizing comprehensive placement search. Placement primitives may also be used in improving or optimizing compactness of placement, such as by allowing only compressed form of placement primitives.

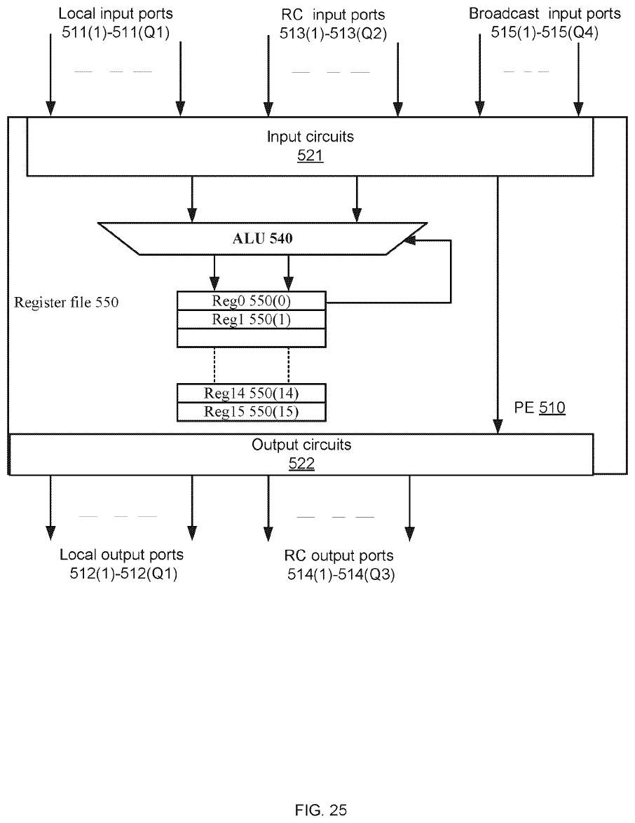

For example, referring to FIG. 25, a PE may include Q1 local input ports 511(1)-511(Q1) and Q1 output ports 512(1)-512(Q1) for locally communicating with Q1 neighbors, may include I/O ports for remote communication (RC) (for example with one or more Benes networks). The I/O ports for RC may include Q2 input ports 513(1)-513(Q2) and Q3 output ports 514(1)-514(Q3) (for example 1 unicast BN output port and 2 unicast BN input ports—although other numbers may be provided). The PE may include Q4 input ports 515(1)-515(Q4) for receiving broadcast (concurrently provided to a group of PEs— such as a line of PEs or a column of PEs or any 2D group of PEs of the array). Q1, Q2, Q3, Q4 and Q5 are positive integers that may exceed two. For example, Q1 may be two or more, Q1 may range between 4-12, Q1 may equals 8, and the like.

The remote connectivity constraints may limit a number of remote connections of a single PE.

The hardware constraints may include different functionalities of at least two PEs of the array of PE.

Steps 510 and 520 may be followed by step 530 of receiving a computation graph (CG) that represents mathematical expressions to be calculated by the array of PEs.

The PPs location information may be determined regardless of the CG. For example—step 510 may be calculated before receiving the CG, may be calculated in off-line, and the like. By avoiding the use of the computation subgraph, the hardware implementations for each placement primitive may be determined more efficiently. [This can be the same added text that we use above for paragraph [0092]. We would like both locations to describe improvements that are provided by avoiding the use of the CG in determining the PP locations.]

Step 530 may be followed by step 540 of determining a location of the PEs of the array of PEs based on the computation graph, the PPs location information, and the hardware constraints.

In some computation graphs there may be a consumer that is not linked to a producer. This can be addresses by using a PP to represent a consumer.

Typically, a PP may represent a connectivity between one or more producer PEs and one or more consumer PE.

The PPs may be fully connected PPs.

Step 540 may include at least one of steps 540(a)-540(t):
a. Segmenting the CG to sub-graphs.
b. Balancing the CG.
c. Segmenting the CG to sub-graphs using Integer Linear Programming (ILP).
d. Segmenting the CG using any a computation process that does not include ILP.
e. Segmenting the CG to sub-graphs and defining edges between sub-graphs to be remote connectivity connections. The remote connectivity connections may be connections to a Benes network.
f. Compensating for latency introduced by the remote connectivity connections.
g. Fitting the sub-graphs to buckets.
h. Fitting the PP to windows. A window may equal a bucket or may differ from a bucket. The dimension of a window may exceed a corresponding dimension of a bucket. The buckets may include at least two buckets that differ from each other by shape. The buckets may include at least two buckets that differ from each other by size.
i. Applying multiple placement iterations.
j. Applying multiple placement iterations based on the PPs location information.
k. Performing multiple sets of placement iterations.
l. Checking locations of PPs.
m. Checking permutations of the PPs—given one or more locations of the PPs.
n. Performing multiple sets of placement iterations, wherein a set of placement iterations may include (a) evaluating, during different placement iterations of the set, gradually increasing combinations of PPs till finding that a certain combination may be not feasible, (b) gradually reducing the combinations, and (c) gradually increasing the combinations.
o. Performing multiple sets of placement iterations, wherein a set of placement iterations may include evaluating, during different placement iterations of the set, gradually increasing combinations of PPs till placing all sub-graphs in the buckets.
p. Performing multiple sets of placement iterations, wherein a set of placement iterations may include (a) selecting a PP to be evaluated, according to the order of PPs to be evaluated, to provide a selected PP, (b) determining a feasibility of locating the selected PP within the bucket and a location of the selected PP within the bucket may be feasible, wherein the determining may be based on the PPs location information and on a current status of the bucket, the current status of the bucket may include s nodes of the bucket that may be already placed in the bucket, (c) when there may be a feasibility of locating the selected PP within the bucket jumping to step (a).
q. Performing multiple sets of placement iterations, wherein a set of placement iterations may include checking a feasibility of a placement of a combination of PPs based on non-feasible placement information.
r. Checking combinations of locations of PPs.
s. Checking combinations of permutations of PPs.
t. Determining an order of PPs to be evaluated during the multiple placement iterations.

Step 540 may be followed by step 550 of forming the array of PEs by placing the PEs based on the determined locations of the PEs.

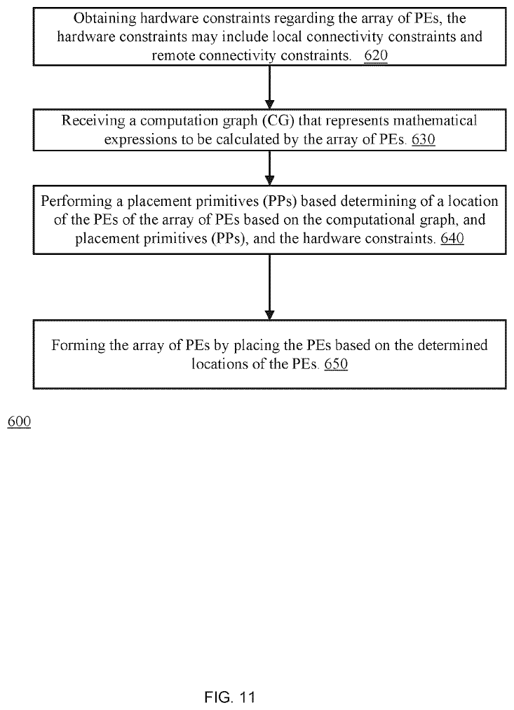

FIG. 11 illustrates an example of method 600 for placement and routing of processing entities (PEs) of an array of PEs.

Method 600 may include step 520 of obtaining hardware constraints regarding the array of PEs, the hardware constraints may include local connectivity constraints and remote connectivity constraints.

Step 520 may be followed by step 530 of receiving a computation graph (CG) that represents mathematical expressions to be calculated by the array of PEs.

Step 530 may be followed by step 640 of performing a placement primitives (PPs) based determining of a location of the PEs of the array of PEs based on the computation graph, and placement primitives (PPs), and the hardware constraints. The PPs to be evaluated during step 640 are ordered. Step 640 may include ordering the PP. The ordering may be determined once and then maintained during multiple fitting iterations.

Step 640 may be executed without receiving PPs location information regarding possible locations of a group of PPs within a window. Alternatively—method 600 may include receiving PPs location information and executing step 640 based, at least in part, on the PPs location information.

Step 640 may include at least one of steps 640(a)-640(s):
a. Segmenting the CG to sub-graphs.
b. Balancing the CG.
c. Segmenting the CG to sub-graphs using Integer Linear Programming (ILP).
d. Segmenting the CG using any a computation process that does not include ILP.
e. Segmenting the CG to sub-graphs and defining edges between sub-graphs to be remote connectivity connections. The remote connectivity connections may be connections to a Benes network.
f. Compensating for latency introduced by the remote connectivity connections.
g. Fitting the sub-graphs to buckets.
h. Fitting the PP to windows. A window may equal a bucket or may differ from a bucket. The dimension of a window may exceed a corresponding dimension of a bucket. The buckets may include at least two buckets that differ from each other by shape. The buckets may include at least two buckets that differ from each other by size.
i. Applying multiple placement iterations.
j. Applying multiple placement iterations based on the PPs location information.
k. Performing multiple sets of placement iterations.
l. Checking locations of PPs.
m. Checking permutations of the PPs—given one or more locations of the PPs.
n. Performing multiple sets of placement iterations, wherein a set of placement iterations may include (a) evaluating, during different placement iterations of the set, gradually increasing combinations of PPs till finding that a certain combination may be not feasible, (b) gradually reducing the combinations, and (c) gradually increasing the combinations.
o. Performing multiple sets of placement iterations, wherein a set of placement iterations may include evaluating, during different placement iterations of the set, gradually increasing combinations of PPs till placing all sub-graphs in the buckets.
p. Performing multiple sets of placement iterations, wherein a set of placement iterations may include (a) selecting a PP to be evaluated, according to the order of PPs to be evaluated, to provide a selected PP, (b) determining a feasibility of locating the selected PP within the bucket and a location of the selected PP within the bucket may be feasible, wherein the determining may be based on the PPs location information and on a current status of the bucket, the current status of the bucket may include s nodes of the bucket that may be already placed in the bucket, (c) when there may be a feasibility of locating the selected PP within the bucket jumping to step (a).
q. Performing multiple sets of placement iterations, wherein a set of placement iterations may include checking a feasibility of a placement of a combination of PPs based on non-feasible placement information.
r. Checking combinations of locations of PPs.
s. Checking combinations of permutations of PPs.

Step 640 may be followed by step 650 of forming the array of PEs by placing the PEs based on the determined locations of the PEs.

In the following example hash values may be provided in binary format and/or in a hexadecimal format. Other formats may be used.

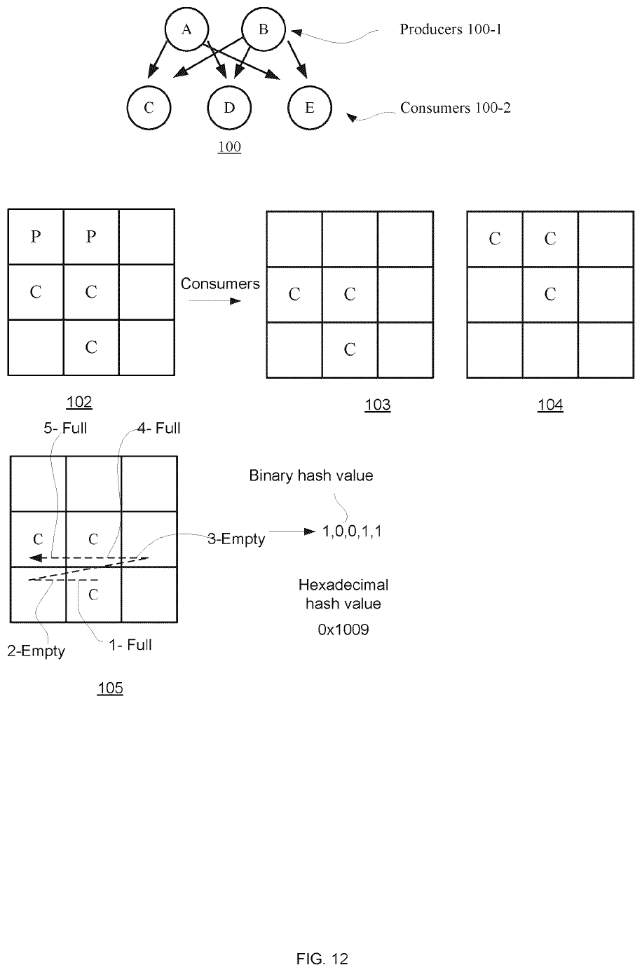

FIG. 12 illustrates an example of an PP 100 that includes two producers (node A and node B) collectively denoted 100-1 and three consumers (node C, node D and node E) collectively denoted 100-2. FIG. 12 also illustrates an allowed hardware implementation 102 of PP 100, a consumers table 103 that shows only the consumers 100-2, and a canonical consumers table 103 that shows only the consumers in a canonical form—in this case aligned to the left top of the table.

FIG. 12 also illustrates a scanning table 105 showing the generation of a consumer hash-value that is obtained while scanning the consumers table 103 from the last consumer to the first consumer (in a raster scan pattern) and allocating a set bit for a consumer and a zero bit for a node not populated by a consumer.

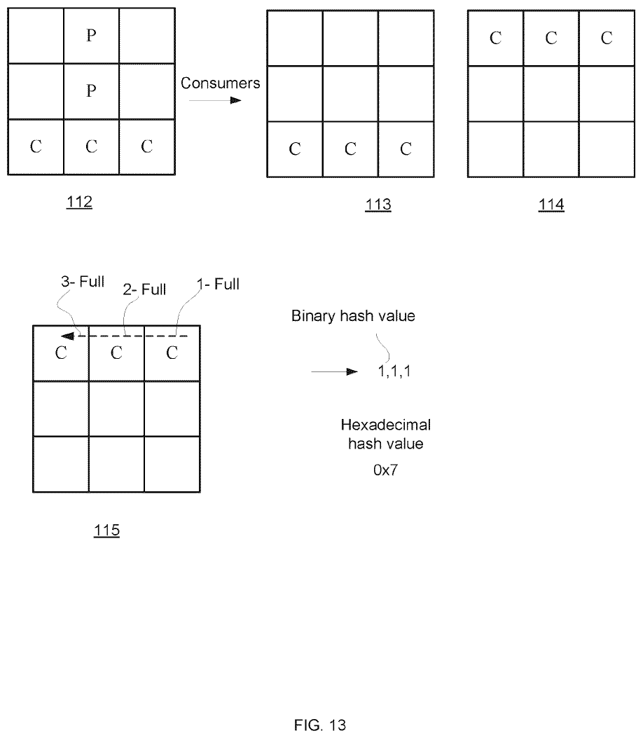

FIG. 13 illustrates another allowed hardware implementation 112 of PP (denoted 100 in FIG. 12), a consumers table 113 that shows only the consumers 100-2, and a canonical consumers table 114 that shows only the consumers in a canonical form—in this case aligned to the left top of the table.

FIG. 13 also illustrates a scanning table 115 showing the generation of a consumer hash-value that is obtained while scanning the consumers table 113 from the last consumer to the first consumer (in a raster scan pattern) and allocating a set bit for a consumer and a zero bit for a node not populated by a consumer.

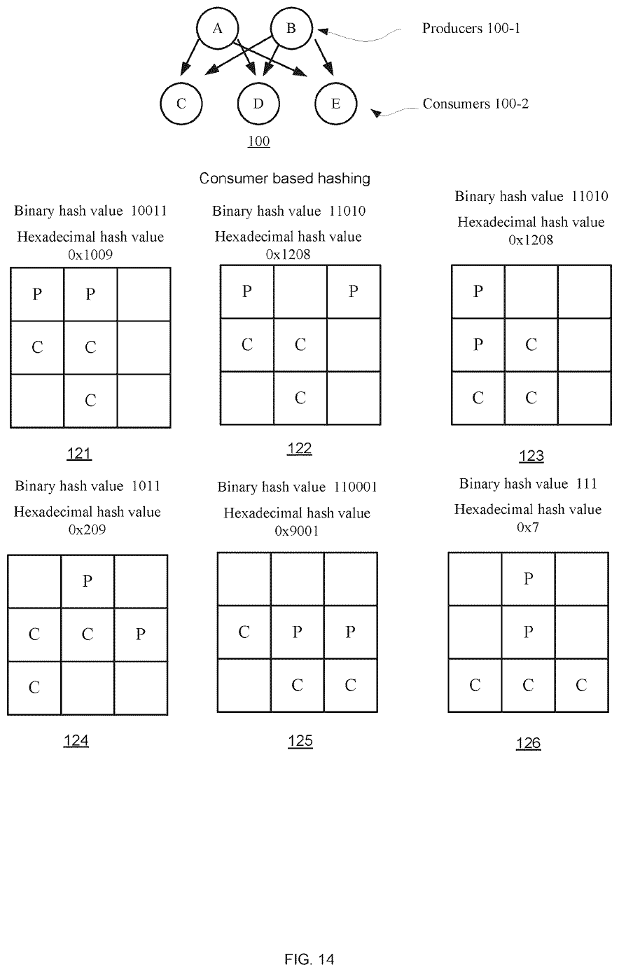

FIG. 14 illustrates an example of an PP 100 that includes two producers (node A and node B) collectively denoted 100-1 and three consumers (node C, node D and node E) collectively denoted 100-2. FIG. 14 also illustrates consumers hash-values of various allowed hardware implementations 121, 122, 123, 124, 125 and 126 of PP 100.

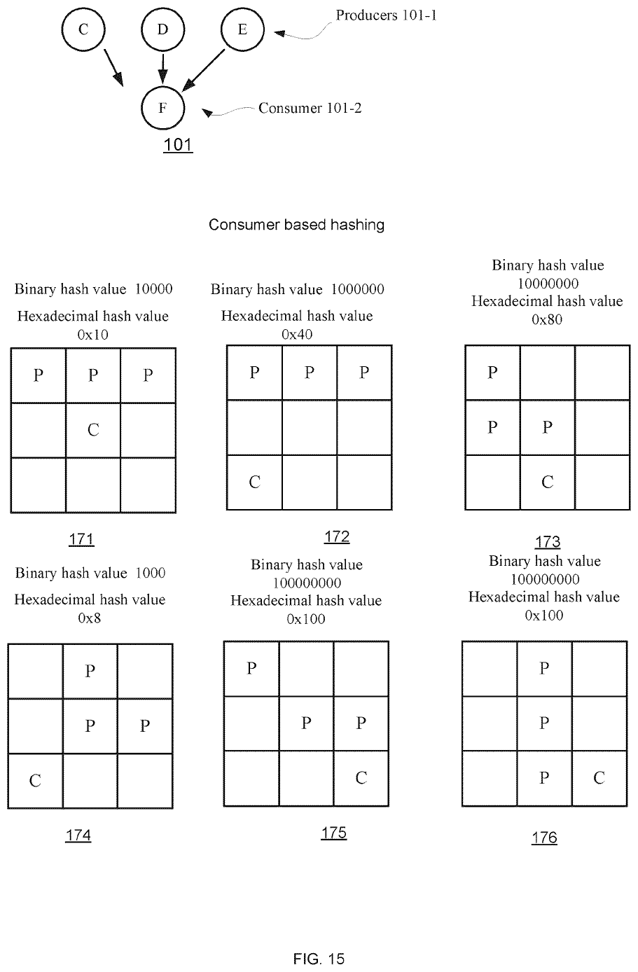

FIG. 15 illustrates an example of an PP 101 that includes three producers (node C, node D and node E) collectively denoted 101-1 and a consumer (node F) collectively denoted 101-2. FIG. 15 also illustrates consumers hash-values of various allowed hardware implementations 171, 172, 173, 174, 175 and 176 of PP 101.

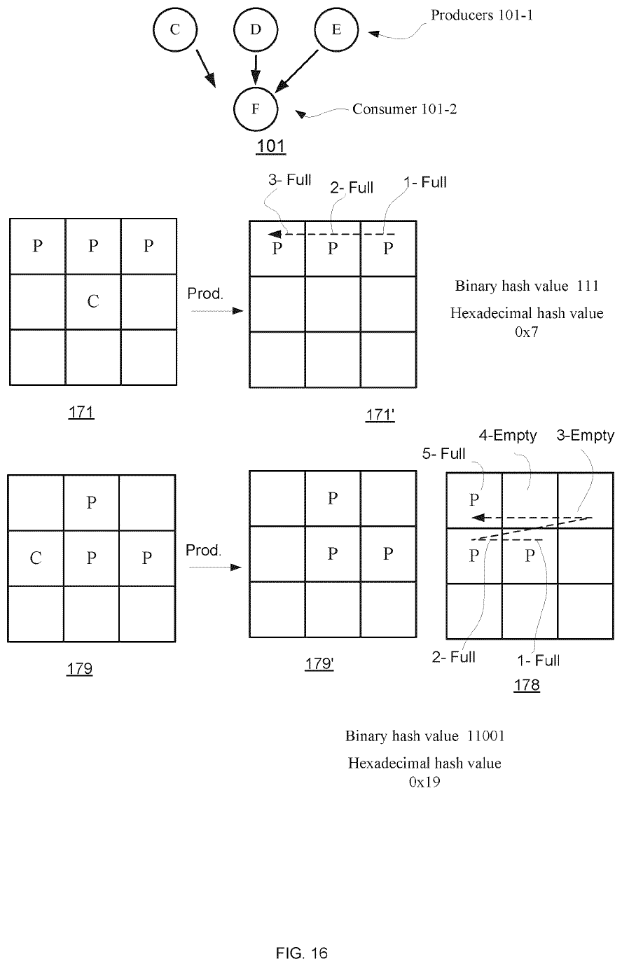

FIG. 16 illustrates an example of an PP 101 that includes three producers (node C, node D and node E) collectively denoted 101-1 and a consumer (node F) collectively denoted 101-2. FIG. 16 also illustrates allowed hardware implementations 171 and 179 of PP 101, producers tables 171′ and 179′ that show only the producers 101-2, and a scanning table 178 showing the generation of producers hash-values that are obtained while scanning producers tables 171′ and 179′ from the last producer to the first producer (in a raster scan pattern) and allocating a set bit for a producer and a zero bit for a node not populated by a producer.

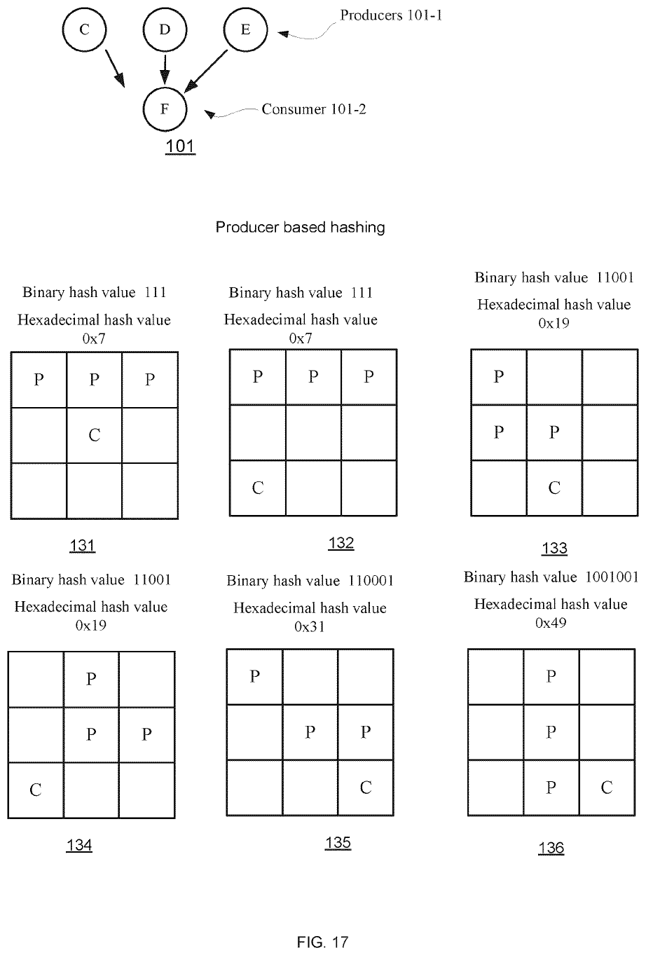

FIG. 17 illustrates an example of PP 101 that includes three producers (node C, node D and node E) collectively denoted 101-1 and a consumer (node F) collectively denoted 101-2. FIG. 17 also illustrates allowed hardware implementations 131, 132, 133, 134, 135 and 136—and their producer hash values that are canonic hash values.

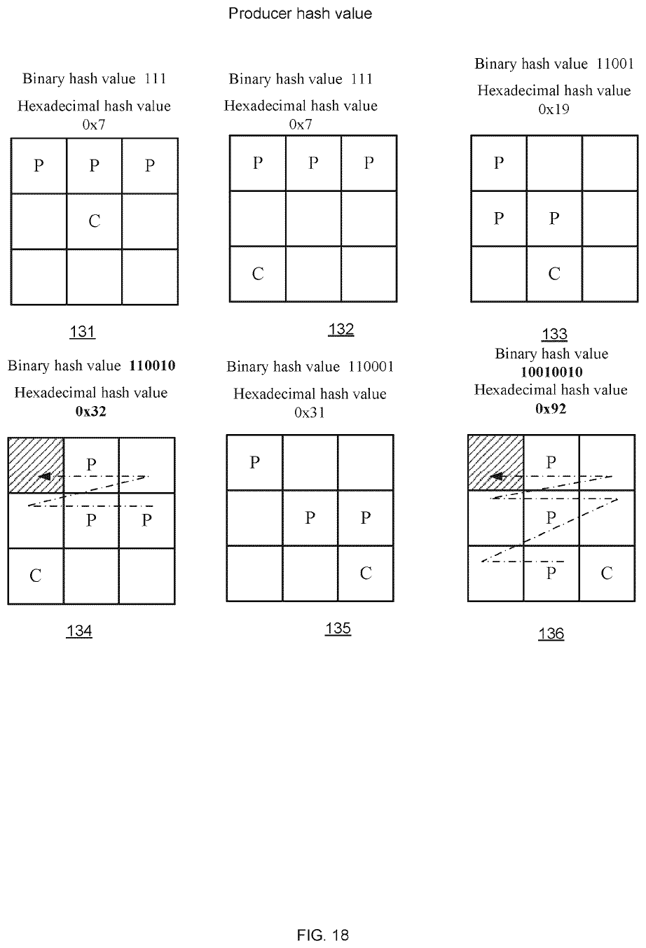

FIG. 18 illustrates allowed hardware implementations 131, 132, 133, 134, 135 and 136—and their producer hash values that are non-canonic hash values and include information regarding the locations of the producers within the table. For example—the binary hash value of each one of allowed hardware implementations 134 and 136 ends with a reset bit to indicate that the left top node of the window is vacant.

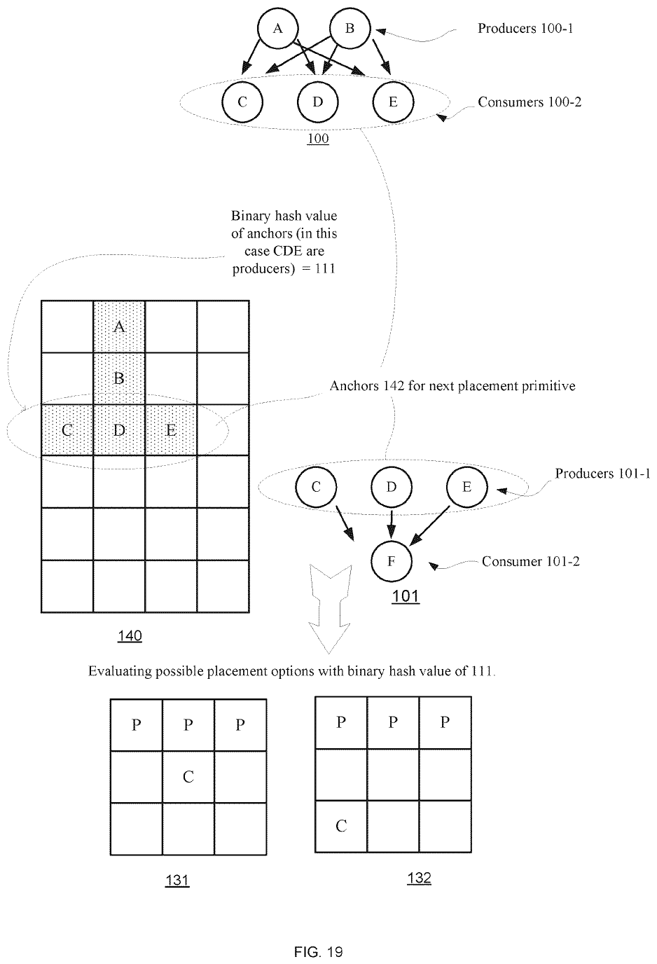

FIG. 19 illustrates a window 140 that includes four by six elements. The window is partially populated by an allowed hardware implementation (denoted 126 of FIG. 14) of PP 100—that include a first producer (node A) above a second producer (node B) that is a above three consumers (nodes C, D and E) that are located side by side—at the same row of window 140.

The window 140 is partially populated and the placement process may include evaluating whether a next placement primitive (PP 101) may also populate the window 140.

Nodes C, D and E are already placed in the window (they are consumers of PP 100). They also belong (as producers) to the next placement primitive.

In order to reduce computation time, the placement process may select, out of multiple allowed hardware implementation of PP 101—only allowed hardware implementation that have a hash value (for example a producer hash value—as nodes C, D, and E are producers of PP 101) that equal the hash value of already placed PP 100—which are allowed hardware implementation 131 and allowed hardware implementation 132.

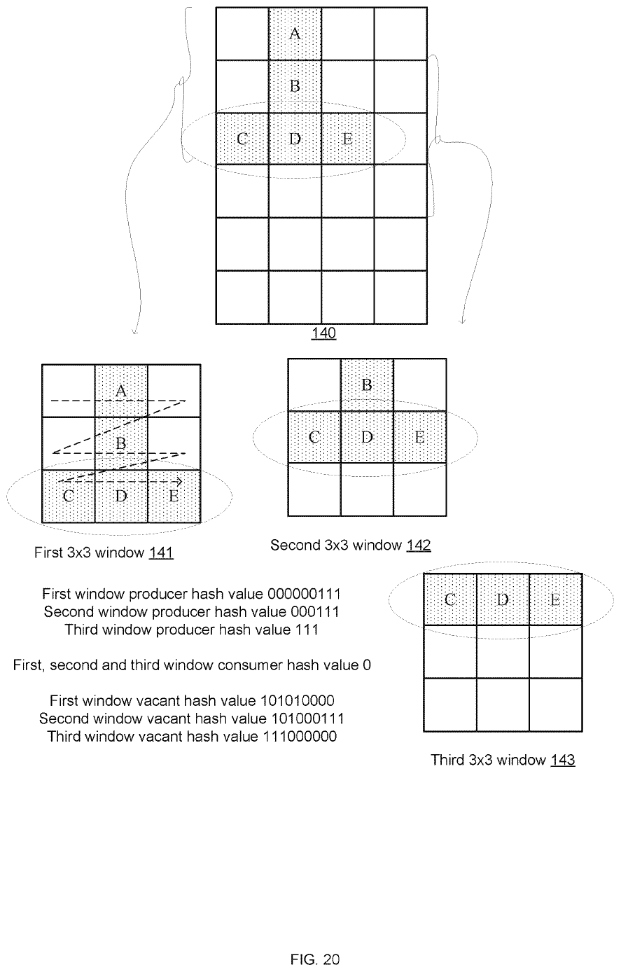

FIG. 20 illustrates an example of evaluating multiple candidate windows 141, 142 and 143 within the larger window 104. The candidate windows are vertically shifted in relation to each other—and the placement process may determine in which candidate window (if any) the allowed hardware implementation of PP 101 may be located.

The determination per window may include calculating any type of hash value (consumer hash value, producer hash value, vacant hash value or a full hash value) and performing one or more Boolean operations to determine if the allowed hardware implementation of PP 101 may be in any of the candidate windows.

In FIG. 20 the producer binary hash value of allowed hardware implementation (denoted 126 of FIG. 14) is 111 and a NAND operation is applied between this producer binary hash value and the producer hash value of each one of the first, second and third candidate windows—to indicate that only the third window is a valid window.

The next step may include performing such comparisons to see if the consumer node (node F) can be placed in the third window.

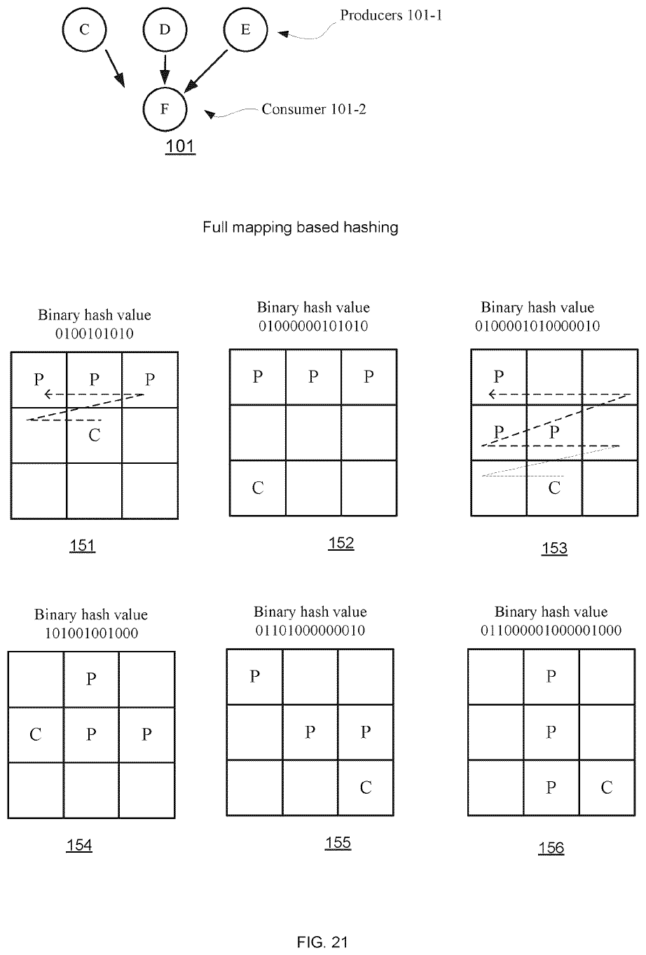

FIG. 21 illustrates example of full mapping-based hashing—in which a single hash value of an allowed hardware implementation represents the consumers, the producers and vacancies of the allowed hardware implementation. The mapping associates a first value (for example 10) to each producer, a second value (for example 01) to each consumer and a third value (for example 00) to each vacant node. The mapping may be a canonical mapping or a non-canonical mapping.

The hash value may be obtained by scanning the allowed hardware implementation—for example from the last non-vacant element of the allowed hardware implementation—and backwards—for example till the first non-vacant element of the allowed hardware implementation or till a predefined location in the table.

The scanning may be according to a raster can pattern—and may be made according to any direction—backwards or forwards.

FIG. 21 illustrates an example of PP 101 that includes three producers (node C, node D and node E) collectively denoted 101-1 and a consumer (node F) collectively denoted 101-2. FIG. 17 also illustrates allowed hardware implementations 151, 152, 153, 154, 155 and 156—and their full hash values.

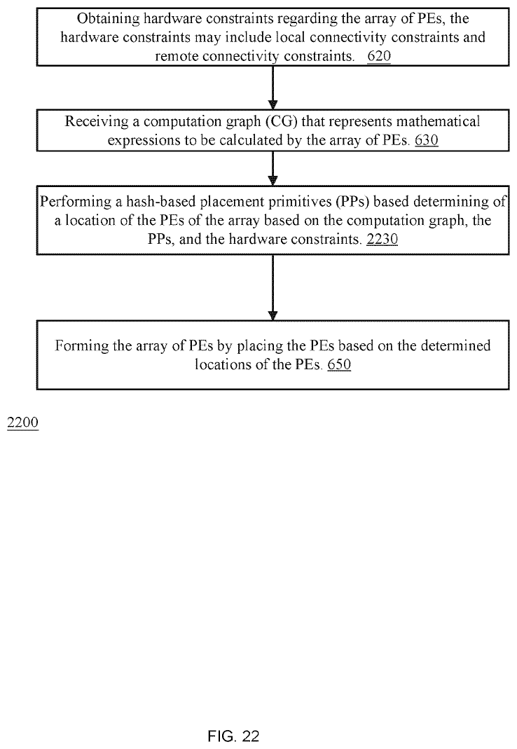

FIG. 22 illustrates an example of method 2200 for hash-based placement of an array of processing entities (PEs).

Method 2200 may include step 620 of obtaining hardware constraints regarding the array, the hardware constraints comprise local connectivity constraints and remote connectivity constraints.

Method 2200 may include step 630 of receiving a computation graph (CG) that represents mathematical expressions to be calculated by the array.

Steps 620 and 630 may be followed by step 2230 of performing a hash-based placement primitives (PPs) based determining of a location of the PEs of the array based on the computation graph, the PPs, and the hardware constraints.

Step 2230 may be followed by step 650 of forming the array of PEs by placing the PEs based on the determined locations of the PEs.

Step 2230 may include performing multiple hash-based sets of placement iterations, wherein a hash-based set of placement iterations is associated with a portion of the array.

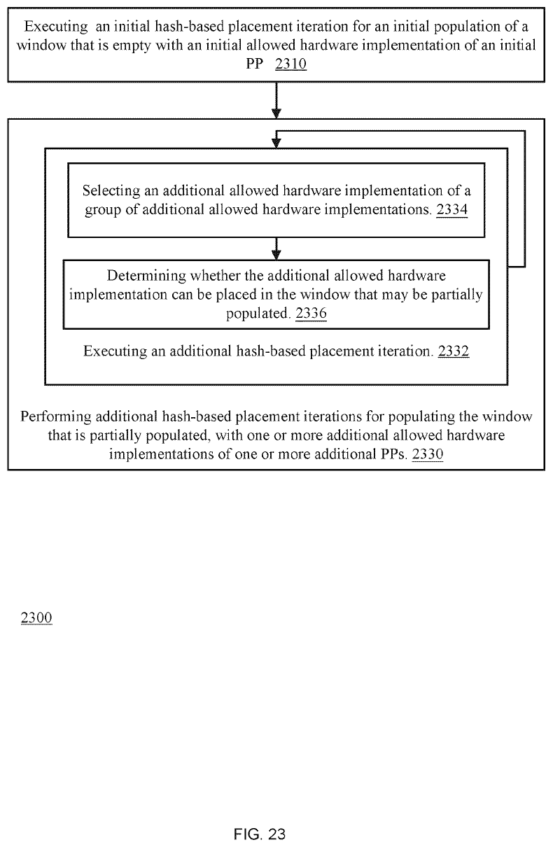

FIG. 23 illustrates method 2300 for executing a hash-based set of placement iteration.

Method 2300 may include step 2310 of executing an initial hash-based placement iteration for an initial population of a window that is empty with an initial allowed hardware implementation of an initial PP.

Step 2310 may be followed by step 2330 of performing additional hash-based placement iterations for populating the window that is partially populated, with one or more additional allowed hardware implementations of one or more additional PPs.

Step 2330 may be executed based on one or more hash-values of one or more populated nodes.

Step 2330 may be executed also based on one or more hash-values of the additional allowed hardware implementations.

Step 2330 may include multiple repetitions of step 2332 of executing an additional hash-based placement iteration. The repetition may continue until reaching a stop condition such as exhausting the search, filling the window so that other allowed hardware implementations cannot be added to the window, and the like.

Step 2332 may include step 2334 of selecting an additional allowed hardware implementation of a group of additional allowed hardware implementations.

The selecting may be based on (i) one or more hash values of members of the group and (ii) one or more hash values of one or more populated nodes that appear, at least in part, in the members of the group.

One or more hash values of a member of the group may include a producer hash value, and a consumer hash value.

One or more hash values of a member of the group may include a producer hash value, a consumer hash value, and a vacant hash value.

One or more hash values of a member of the group may include a hash value that may be indicative of producers, consumers and vacant nodes.

One or more hash values of a member of the group may be a canonical hash value.

One or more hash values of a member of the group may be a non-canonical hash value.

The selecting may include selecting a member of the group that has one or more hash values that equal the one or more hash values of one or more populated nodes that appear in the member of the group.

One or more hash values of a member of the group may be one or more bitmaps.

Step 2332 may also include step 2336 (that follows step 2334) of determining whether the additional allowed hardware implementation can be placed in the window that may be partially populated.

Step 2336 may include performing one or more Boolean operations.

A Boolean operation of the one or more Boolean operations may be applied on a hash value of the one or more populated nodes and on a hash value of the additional allowed hardware implementation.

The Boolean operation may be a NAND operation—or another Boolean operation.

The one or more Boolean operations may include a producer Boolean operation that may be applied on producer hash-values, and a consumer Boolean operation that may be applied on consumer hash-values.

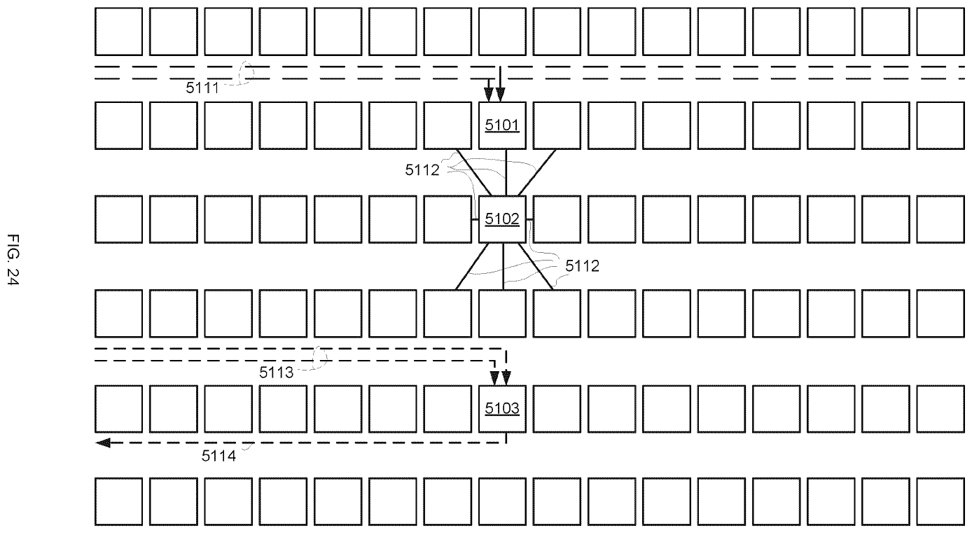

FIG. 24 illustrates an array of PEs and illustrates local input and output ports 5112 (one line per neighbor PE) of PE 5102, two input ports 5111 of PE 5101 for receiving broadcasts, one output RC port 5114 of PE 5103 and two input RC ports 5113 of PE 5103. A single PE may have all three types of ports—but for brevity of explanation different types of ports are shown in relation to different PEs.

FIG. 25 illustrates an example of PE 510 that may include Q1 local input ports 511(1)-511(Q1) and Q1 output ports 512(1)-512(Q1) for locally communicating with Q1 neighbors, may include I/O ports for remote communication (RC) (for example with one or more Benes networks). The I/O ports for RC may include Q2 input ports 513(1)-513(Q2) and Q3 output ports 514(1)-514(Q3) (for example 1 unicast BN output port and 2 unicast BN input ports—although other numbers may be provided). The PE may include Q4 input ports 515(1)-515(Q4) for receiving broadcast (concurrently provided to a group of PEs— such as a line of PEs or a column of PEs or any 2D group of PEs of the array). PE 510 may also include input circuits 521 (for example multiple multiplexers and control signals) for receiving content from the input ports and conveying the content to a computation core that may include an arithmetic logic unit (ALU) 450, and registers 550(0)-550(15) of a register file 550. The content of the computation core and/or content from the input circuits may be fed to output circuits 522 (for example multiple multiplexers and control signals) that output the content from any of the output ports of PE 510.

The subject matter regarded as the embodiments of the disclosure is particularly pointed out and distinctly claimed in the concluding portion of the specification. The embodiments of the disclosure, however, both as to organization and method of operation, together with objects, features, and advantages thereof, may best be understood by reference to the following detailed description when read with the accompanying drawings.

It will be appreciated that for simplicity and clarity of illustration, elements shown in the FIGs. have not necessarily been drawn to scale. For example, the dimensions of some of the elements may be exaggerated relative to other elements for clarity. Further, where considered appropriate, reference numerals may be repeated among the FIGs. to indicate corresponding or analogous elements.

Because the illustrated embodiments of the disclosure may for the most part, be implemented using electronic components and circuits known to those skilled in the art, details will not be explained in any greater extent than that considered necessary as illustrated above, for the understanding and appreciation of the underlying concepts of the present embodiments of the disclosure and in order not to obfuscate or distract from the teachings of the present embodiments of the disclosure.

Any reference in the specification to a method should be applied mutatis mutandis to a system capable of executing the method and should be applied mutatis mutandis to a computer readable medium that is non-transitory and stores instructions for executing the method.

Any reference in the specification to a system should be applied mutatis mutandis to a method that may be executed by the system and should be applied mutatis mutandis to a computer readable medium that is non-transitory and stores instructions executable by the system.

Any reference in the specification to a computer readable medium that is non-transitory should be applied mutatis mutandis to a method that may be applied when executing instructions stored in the computer readable medium and should be applied mutatis mutandis to a system configured to execute the instructions stored in the computer readable medium.

The term “and/or” means additionally or alternatively.

A processing circuit may be implemented as a central processing unit (CPU), an application-specific integrated circuit (ASIC), a field programmable gate arrays (FPGA), a full-custom integrated circuit, a graphic processing unit (GPU), a hardware accelerator, a system on chip, and the like.

Any reference to any of the terms “comprise,” “comprises,” “comprising” “including,” “may include” and “includes” may be applied to any of the terms “consists,” “consisting,” “and consisting essentially of.” For example, any of method describing steps may include more steps than those illustrated in the figures, only the steps illustrated in the figures or substantially only the steps illustrate in the figures. The same applies to components of a device, processor, or system and to instructions stored in any non-transitory computer readable storage medium.

The subject matter may also be implemented in a computer program for running on a computer system, at least including code portions for performing steps of a method according to the subject matter when run on a programmable apparatus, such as a computer system or enabling a programmable apparatus to perform functions of a device or system according to the subject matter. The computer program may cause the storage system to allocate disk drives to disk drive groups.

A computer program is a list of instructions such as a particular application program or an operating system. The computer program may for instance include one or more of: a subroutine, a function, a procedure, an object method, an object implementation, an executable application, an applet, a servlet, a source code, an object code, a shared library/dynamic load library or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as flash memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory, and a number of input/output (I/O) devices. When executing the computer program, the computer system processes information according to the computer program and produces resultant output information via I/O devices.

In the foregoing specification, the subject matter has been described with reference to specific examples of embodiments of the subject matter. It will, however, be evident that various modifications and changes may be made therein without departing from the broader spirit and scope of the subject matter as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the subject matter described herein are, for example, capable of operation in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein may be designed as either negative or positive logic signals. Therefore, in alternate embodiments, those signals described as positive logic signals may be implemented as negative logic signals, and those signals described as negative logic signals may be implemented as positive logic signals.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative, and that alternative embodiments may merge logic blocks or circuit elements, or may impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above-described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

The illustrated examples may be implemented as circuitry located on a single integrated circuit or within a same device. Alternatively, the examples may be implemented as any number of separate integrated circuits or separate devices interconnected with each other in a suitable manner. The examples, or portions thereof, may implemented as soft or code representations of physical circuitry or of logical representations convertible into physical circuitry, such as in a hardware description language of any appropriate type.

Example 1 is a method for placement and routing of processing entities (PEs) of an array of PEs, the method comprises: obtaining placement primitive (PP) location window information, the location window information defining possible locations of a group of PPs within a coarse-grained reconfigurable array (CGRA); obtaining hardware constraints regarding the array of PEs, the hardware constraints comprise local connectivity constraints and remote connectivity constraints; receiving a computation graph (CG) that represents mathematical expressions to be calculated by the array of PEs; and determining a location of the PEs of the array of PEs based on the CG, the PP location window information, and hardware constraints.

In Example 2, the subject matter of Example 1 includes, wherein the PP location window information is determined prior to receiving the CG.

In Example 3, the subject matter of Examples 1-2 includes, wherein the PP location window information represent local connectivity constraints.

In Example 4, the subject matter of Examples 1-3 includes, wherein a PP of the PPs represents a consumer.

In Example 5, the subject matter of Examples 1-4 includes, wherein each PP of at least two PPs of the group of PPs represents a connectivity between one or more producer PEs and one or more consumer PE.

In Example 6, the subject matter of Examples 1-5 includes, segmenting the CG to sub-graphs.

In Example 7, the subject matter of Example 6 includes, segmenting the CG to sub-graphs using Integer Linear Programming.

In Example 8, the subject matter of Examples 6-7 includes, segmenting the CG to sub-graphs; and identifying remote connectivity connections based on edges between sub-graphs and on the remote connectivity constraints.

In Example 9, the subject matter of Example 8 includes, wherein remote connectivity connections are connections to a Benes network.

In Example 10, the subject matter of Examples 8-9 includes, wherein the segmenting comprises compensating for latency introduced by the remote connectivity connections.

In Example 11, the subject matter of Examples 6-10 includes, wherein the local connectivity constraints define point-to-point connections between the PEs, wherein a point-to-point connection connects a PE to neighbor of the PE.

In Example 12, the subject matter of Examples 6-11 includes, fitting the sub-graphs to buckets.

In Example 13, the subject matter of Example 12 includes, placing PPs within windows associated with the buckets by applying multiple placement iterations.

In Example 14, the subject matter of Example 13 includes, wherein the multiple placement iterations are based on the PPs location information.

In Example 15, the subject matter of Example 14 includes, wherein a window associated with a bucket does not exceed the bucket.

In Example 16, the subject matter of Examples 14-15 includes, determining an order of PPs to be evaluated during the multiple placement iterations.

In Example 17, the subject matter of Example 16 includes, wherein the multiple placement iterations comprise multiple sets of placement iterations.

In Example 18, the subject matter of Examples 16-17 includes, wherein the multiple placement iterations comprise checking combination of locations of PPs and of permutations of the PPs.

In Example 19, the subject matter of Examples 16-18 includes, wherein the multiple placement iterations comprise multiple sets of placement iterations.

In Example 20, the subject matter of Example 19 includes, wherein a set of placement iterations includes (a) evaluating, during different placement iterations of the set, gradually increasing combinations of PPs till finding that a certain combination is not feasible, (b) gradually reducing the combinations, and (c) gradually increasing the combinations.

In Example 21, the subject matter of Examples 19-20 includes, wherein a set of placement iterations includes (a) evaluating, during different placement iterations of the set, gradually increasing combinations of PPs till placing all sub-graphs in the buckets.

In Example 22, the subject matter of Examples 19-21 includes, wherein a set of placement iterations comprises: selecting a PP to be evaluated, according to the order of PPs to be evaluated, to provide a selected PP; determining a feasibility of locating the selected PP within the bucket and a location of the selected PP within the bucket is feasible, wherein the determining is based on the PPs location information and on a current status of the bucket, the current status of the bucket comprises nodes of the bucket that are already placed in the bucket; and when there is a feasibility of locating the selected PP within the bucket, selecting a new PP to be evaluated, according to the order of PPs to be evaluated, to provide a new selected PP.

In Example 23, the subject matter of Examples 19-22 includes, wherein the determining is based on at least one of local connectivity constraints or remote connectivity constraints.

In Example 24, the subject matter of Examples 19-23 includes, wherein a set of placement iterations includes comprises checking a feasibility of a placement of a combination of PPs based on non-feasible placement information.

In Example 25, the subject matter of Example 24 includes, wherein checking the feasibility of the placement of the combination of PPs is further based a processing entity (PE) feasibility.

In Example 26, the subject matter of Example 25 includes, wherein the PE feasibility is based on a pre-placement of another PE.

In Example 27, the subject matter of Examples 16-26 includes, wherein the multiple placement iterations comprise checking combination of locations of PPs.

In Example 28, the subject matter of Examples 16-27 includes, wherein the multiple placement iterations comprise checking combination of permutations of PPs.

In Example 29, the subject matter of Examples 14-28 includes, wherein a dimension of the window exceeds a corresponding dimension of a bucket.

In Example 30, the subject matter of Examples 12-29 includes, wherein the buckets comprise at least two buckets that differ from each other by shape.

In Example 31, the subject matter of Examples 12-30 includes, wherein the buckets comprise at least two buckets that differ from each other by size.

In Example 32, the subject matter of Examples 8-31 includes, time balancing the CG before the segmenting of the CG to sub-graphs.

In Example 33, the subject matter of Example 32 includes, wherein the time balancing comprises using Integer Linear Programming.

In Example 34, the subject matter of Examples 8-33 includes, wherein the segmenting is executed while following the remote connectivity constraints.

In Example 35, the subject matter of Example 34 includes, wherein the remote connectivity constraints limit a number of remote connections of a single PE.

In Example 36, the subject matter of Examples 34-35 includes, wherein the hardware constraints comprise different functionalities of at least two PEs of the array of PE.

In Example 37, the subject matter of Examples 34-36 includes, wherein the group of PPs include fully connected placement primitives.

In Example 38, the subject matter of Examples 1-37 includes, forming the array of PEs by placing the PEs based on the determining of the location of the PEs.

Example 39 is a method for order-based placement and routing of processing entities (PEs) of an array of PEs, the method comprises: obtaining hardware constraints regarding the array of PEs, the hardware constraints comprise local connectivity constraints and remote connectivity constraints; receiving a computation graph (CG) that represents mathematical expressions to be calculated by the array of PEs; and performing a placement primitives (PPs) based determining of a location of the PEs of the array of PEs based on the computation graph, the PPs, and the hardware constraints; wherein the PPs based determining comprises determining an order of PPs to be evaluated during the PPs based determining.

In Example 40, the subject matter of Example 39 includes, obtaining PPs location information regarding possible locations of a group of PPs within a window.

In Example 41, the subject matter of Example 40 includes, wherein each PP represents a connectivity between one or more producer PEs and one or more consumer PE.

In Example 42, the subject matter of Examples 40-41 includes, wherein at least one PP represents a producer.

In Example 43, the subject matter of Examples 40-42 includes, segmenting the CG to sub-graphs.

In Example 44, the subject matter of Example 43 includes, segmenting the CG to sub-graphs using Integer Linear Programming.

In Example 45, the subject matter of Examples 43-44 includes, segmenting the CG to sub-graphs and defining edges between sub-graphs to be remote connectivity connections.

In Example 46, the subject matter of Example 45 includes, wherein remote connectivity connections are connections to a Benes network.

In Example 47, the subject matter of Examples 45-46 includes, wherein the segmenting comprises compensating for latency introduced by the remote connectivity connections.

In Example 48, the subject matter of Examples 43-47 includes, wherein the local connectivity constraints define point-to-point connections between the PEs, wherein a point-to-point connection connects a PE to neighbor of the PE.

In Example 49, the subject matter of Examples 43-48 includes, fitting the sub-graphs to buckets.

In Example 50, the subject matter of Example 49 includes, placing PPs within windows associated with the buckets by applying multiple placement iterations.

In Example 51, the subject matter of Example 50 includes, wherein the multiple placement iterations are based on the PPs location information.

In Example 52, the subject matter of Example 51 includes, wherein a window associated with a bucket does not exceed the bucket.

In Example 53, the subject matter of Examples 51-52 includes, determining an order of PPs to be evaluated during the multiple placement iterations.

In Example 54, the subject matter of Example 53 includes, wherein the multiple placement iterations comprise multiple sets of placement iterations.

In Example 55, the subject matter of Examples 53-54 includes, wherein the multiple placement iterations comprise checking combination of locations of PPs and of permutations of the PPs.

In Example 56, the subject matter of Examples 53-55 includes, wherein the multiple placement iterations comprise multiple sets of placement iterations.

In Example 57, the subject matter of Example 56 includes, wherein a set of placement iterations includes (a) evaluating, during different placement iterations of the set, gradually increasing combinations of PPs till finding that a certain combination is not feasible, (b) gradually reducing the combinations, and (c) gradually increasing the combinations.

In Example 58, the subject matter of Examples 56-57 includes, wherein a set of placement iterations includes (a) evaluating, during different placement iterations of the set, gradually increasing combinations of PPs till placing all sub-graphs in the buckets.

In Example 59, the subject matter of Examples 56-58 includes, wherein a set of placement iterations comprises: selecting a PP to be evaluated, according to the order of PPs to be evaluated, to provide a selected PP; determining a feasibility of locating the selected PP within the bucket and a location of the selected PP within the bucket is feasible, wherein the determining is based on the PPs location information and on a current status of the bucket, the current status of the bucket comprises nodes of the bucket that are already placed in the bucket; and when there is a feasibility of locating the selected PP within the bucket, selecting a new PP to be evaluated, according to the order of PPs to be evaluated, to provide a new selected PP.

In Example 60, the subject matter of Examples 56-59 includes, wherein a set of placement iterations includes comprises checking a feasibility of a placement of a combination of PPs based on non-feasible placement information.

In Example 61, the subject matter of Examples 53-60 includes, wherein the multiple placement iterations comprise checking combination of locations of PPs.

In Example 62, the subject matter of Examples 53-61 includes, wherein the multiple placement iterations comprise checking combination of permutations of PPs.

In Example 63, the subject matter of Examples 51-62 includes, wherein a dimension of the window exceeds a corresponding dimension of a bucket.

In Example 64, the subject matter of Examples 49-63 includes, wherein the buckets comprise at least two buckets that differ from each other by shape.

In Example 65, the subject matter of Examples 49-64 includes, wherein the buckets comprise at least two buckets that differ from each other by size.

In Example 66, the subject matter of Examples 45-65 includes, time balancing the CG before the segmenting of the CG to sub-graphs.

In Example 67, the subject matter of Example 66 includes, wherein the time balancing comprises using Integer Linear Programming.

In Example 68, the subject matter of Examples 45-67 includes, wherein the segmenting is executed while following the remote connectivity constraints.

In Example 69, the subject matter of Example 68 includes, wherein the remote connectivity constraints limit a number of remote connections of a single PE.

In Example 70, the subject matter of Examples 68-69 includes, wherein the hardware constraints comprise different functionalities of at least two PEs of the array of PE.

In Example 71, the subject matter of Examples 68-70 includes, wherein the group of PPs include fully connected placement primitives.

In Example 72, the subject matter of Example 71 includes, forming the array of PEs by placing the PEs based on the determining of the location of the PEs.

Example 73 is a method for hash-based placement of an array of processing entities (PEs), the method comprises: obtaining hardware constraints regarding the array, the hardware constraints comprise local connectivity constraints and remote connectivity constraints; receiving a computation graph (CG) that represents mathematical expressions to be calculated by the array; and performing a hash-based placement primitives (PPs) based determining of a location of the PEs of the array based on the computation graph, the PPs, and the hardware constraints; wherein the hash-based PPs based determining comprises performing multiple hash-based sets of placement iterations, wherein a hash-based set of placement iterations is associated with a portion of the array, wherein the hash-based set of placement iterations comprises: an initial hash-based placement iteration for an initial population of a window that is empty with an initial allowed hardware implementation of an initial PP; and additional hash-based placement iterations for populating the window that is partially populated, with one or more additional allowed hardware implementations of one or more additional PPs; wherein the additional hash-based placement iterations are executed based on one or more hash-values of one or more populated nodes.

In Example 74, the subject matter of Example 73 includes, wherein the additional hash-based placement iterations are also based on one or more hash-values of the additional allowed hardware implementations.

In Example 75, the subject matter of Example 74 includes, wherein an additional hash-based placement iteration comprises selecting an additional allowed hardware implementation of a group of additional allowed hardware implementations.

In Example 76, the subject matter of Example 75 includes, wherein the selecting is based on (i) one or more hash values of members of the group and (ii) one or more hash values of one or more populated nodes that appear, at least in part, in the members of the group.

In Example 77, the subject matter of Example 76 includes, wherein one or more hash values of a member of the group comprise a producer hash value, and a consumer hash value.

In Example 78, the subject matter of Examples 76-77 includes, wherein one or more hash values of a member of the group comprise a producer hash value, a consumer hash value, and a vacant hash value.

In Example 79, the subject matter of Examples 76-78 includes, wherein one or more hash values of a member of the group comprise a hash value that is indicative of producers, consumers and vacant nodes.

In Example 80, the subject matter of Examples 76-79 includes, wherein one or more hash values of a member of the group is a canonical hash value.

In Example 81, the subject matter of Examples 76-80 includes, wherein one or more hash values of a member of the group is a non-canonical hash value.

In Example 82, the subject matter of Examples 76-81 includes, wherein the selecting comprising selecting a member of the group that has one or more hash values that equal the one or more hash values of one or more populated nodes that appear in the member of the group.

In Example 83, the subject matter of Examples 76-82 includes, wherein one or more hash values of a member of the group are one or more bitmaps.

In Example 84, the subject matter of Examples 75-83 includes, wherein the selecting of the additional allowed hardware implementation is followed by determining whether the additional allowed hardware implementation can be placed in the window that is partially populated.

In Example 85, the subject matter of Example 84 includes, wherein determining whether the additional allowed hardware implementation can be placed in the window comprises performing one or more Boolean operations.

In Example 86, the subject matter of Example 85 includes, wherein a Boolean operation of the one or more Boolean operations is applied on a hash value of the one or more populated nodes and on a hash value of the additional allowed hardware implementation.

In Example 87, the subject matter of Example 86 includes, wherein the Boolean operation is a NAND operation.

In Example 88, the subject matter of Examples 85-87 includes, wherein the one or more Boolean operations comprise a producer Boolean operation that is applied on producer hash-values, and a consumer hash-value that is applied on consumer hash-values.

Example 89 is a method for placement and routing of processing entities (PEs) of an array of PEs, the method comprises: obtaining placement primitives (PPs) location information regarding possible locations of a group of PPs within a window; obtaining hardware constraints regarding the array of PEs, the hardware constraints comprise local connectivity constraints and remote connectivity constraints; receiving a computation graph (CG) that represents mathematical expressions to be calculated by the array of PEs; wherein the PPs location information is determined regardless of the CG; and determining a location of the PEs of the array of PEs based on the computation graph, the PPs location information, and hardware constraints.

Example 90 is a non-transitory computer readable medium for placement and routing of processing entities (PEs) of an array of PEs, the non-transitory computer readable medium comprising instructions that, responsive to being executed with processor circuitry of a computer-controlled device, cause the processor circuitry to: obtain placement primitives (PPs) location information regarding possible locations of a group of PPs within a window; obtain hardware constraints regarding the array of PEs, the hardware constraints comprise local connectivity constraints and remote connectivity constraints; receive a computation graph (CG) that represents mathematical expressions to be calculated by the array of PEs; wherein the PPs location information is determined regardless of the CG; and determine a location of the PEs of the array of PEs based on the computation graph, the PPs location information, and hardware constraints.

Example 91 is a non-transitory computer readable medium for placement and routing of processing entities (PEs) of an array of PEs, the non-transitory computer readable medium comprising instructions that, responsive to being executed with processor circuitry of a computer-controlled device, cause the processor circuitry to: obtain hardware constraints regarding the array of PEs, the hardware constraints comprise local connectivity constraints and remote connectivity constraints; receive a computation graph (CG) that represents mathematical expressions to be calculated by the array of PEs; and perform a placement primitives (PPs) based determining of a location of the PEs of the array of PEs based on the computation graph, the PPs, and the hardware constraints; wherein the PPs based determining comprises determining an order of PPs to be evaluated during the PPs based determination.

Example 92 is a non-transitory computer readable medium for has based placement and routing of processing entities (PEs) of an array of PEs, the non-transitory computer readable medium comprising instructions that, responsive to being executed with processor circuitry of a computer-controlled device, cause the processor circuitry to: obtain hardware constraints regarding the array, the hardware constraints comprise local connectivity constraints and remote connectivity constraints; receive a computation graph (CG) that represents mathematical expressions to be calculated by the array; and perform a hash-based placement primitives (PPs) based determining of a location of the PEs of the array based on the computation graph, the PPs, and the hardware constraints; wherein the hash-based PPs based determining comprises performing multiple hash-based sets of placement iterations, wherein a hash-based set of placement iterations is associated with a portion of the array, wherein the hash-based set of placement iterations comprises: an initial hash-based placement iteration for an initial population of a window that is empty with an initial allowed hardware implementation of an initial PP, and additional hash-based placement iterations for populating the window that is partially populated, with one or more additional allowed hardware implementations of one or more additional PPs; wherein the additional hash-based placement iterations are executed based on one or more hash-values of one or more populated nodes.

Example 93 is at least one machine-readable medium including instructions that, when executed by processing circuitry, cause the processing circuitry to perform operations to implement of any of Examples 1-92.

Example 94 is an apparatus comprising means to implement of any of Examples 1-92.

Example 95 is a system to implement of any of Examples 1-92.

Example 96 is a method to implement of any of Examples 1-92.

The subject matter is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as “computer systems.”

Other modifications, variations and alternatives are also possible. The specifications and drawings are, accordingly, to be regarded in an illustrative rather than in a restrictive sense.

In the claims, any reference signs placed between parentheses shall not be construed as limiting the claim. The word “comprising” does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to the subject matter containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the subject matter have been illustrated and described herein, many modifications, substitutions, changes, and equivalents will now occur to those of ordinary skill in the art. It is, therefore, to be understood that the appended claims are intended to cover all such modifications and changes as fall within the true spirit of the subject matter.

1. A method for placement and routing of processing entities (PEs) of an array of PEs, the method comprises:
obtaining placement primitive (PP) location window information, the location window information defining possible locations of a group of PPs within a coarse-grained reconfigurable array (CGRA);
obtaining hardware constraints regarding the array of PEs, the hardware constraints comprise local connectivity constraints and remote connectivity constraints;
receiving a computation graph (CG) that represents mathematical expressions to be calculated by the array of PEs; and
determining a location of the PEs of the array of PEs based on the CG, the PP location window information, and hardware constraints.

2. The method according to claim 1, wherein the PP location window information is determined prior to receiving the CG.

3-5. (canceled)

6. The method according to claim 1, comprising segmenting the CG to sub-graphs.

7-11. (canceled)

12. The method according to claim 6, comprising fitting the sub-graphs to buckets.

13. The method according to claim 12, comprising placing PPs within windows associated with the buckets by applying multiple placement iterations.

14. The method according to claim 13, wherein the multiple placement iterations are based on the PPs location information.

15. (canceled)

16. The method according to claim 14, comprising determining an order of PPs to be evaluated during the multiple placement iterations.

17-18. (canceled)

19. The method according to claim 16, wherein the multiple placement iterations comprise multiple sets of placement iterations.

20. The method according to claim 19, wherein a set of placement iterations includes (a) evaluating, during different placement iterations of the set, gradually increasing combinations of PPs till finding that a certain combination is not feasible, (b) gradually reducing the combinations, and (c) gradually increasing the combinations.

21. (canceled)

22. The method according to claim 19, wherein a set of placement iterations comprises:
selecting a PP to be evaluated, according to the order of PPs to be evaluated, to provide a selected PR;
determining a feasibility of locating the selected PP within the bucket and a location of the selected PP within the bucket is feasible, wherein the determining is based on the PPs location information and on a current status of the bucket, the current status of the bucket comprises nodes of the bucket that are already placed in the bucket; and
when there is a feasibility of locating the selected PP within the bucket, selecting a new PP to be evaluated, according to the order of PPs to be evaluated, to provide a new selected PP.

23-38. (canceled)

39. A method for order-based placement and routing of processing entities (PEs) of an array of PEs, the method comprises:
obtaining hardware constraints regarding the array of PEs, the hardware constraints comprise local connectivity constraints and remote connectivity constraints;
receiving a computation graph (CG) that represents mathematical expressions to be calculated by the array of PEs; and
performing a placement primitives (PPs) based determining of a location of the PEs of the array of PEs based on the computation graph, the PPs, and the hardware constraints; wherein the PPs based determining comprises determining an order of PPs to be evaluated during the PPs based determining.

40. The method according to claim 39, comprising obtaining PPs location information regarding possible locations of a group of PPs within a window.

41-42. (canceled)

43. The method according to claim 40, comprising segmenting the CG to sub-graphs.

44. (canceled)

45. The method according to claim 43, comprising segmenting the CG to sub-graphs and defining edges between sub-graphs to be remote connectivity connections.

46-65. (canceled)

66. The method according to claim 45, comprising time balancing the CG before the segmenting of the CG to sub-graphs.

67-72. (canceled)

73. A method for hash-based placement of an array of processing entities (PEs), the method comprises:
obtaining hardware constraints regarding the array, the hardware constraints comprise local connectivity constraints and remote connectivity constraints;
receiving a computation graph (CC) that represents mathematical expressions to be calculated by the array; and
performing a hash-based placement primitives (PPs) based determining of a location of the PEs of the array based on the computation graph, the PPs, and the hardware constraints;
wherein the hash-based PPs based determining comprises performing multiple hash-based sets of placement iterations, wherein a hash-based set of placement iterations is associated with a portion of the array, wherein the hash-based set of placement iterations comprises:
an initial hash-based placement iteration for an initial population of a window that is empty with an initial allowed hardware implementation of an initial PP; and
additional hash-based placement iterations for populating the window that is partially populated, with one or more additional allowed hardware implementations of one or more additional PPs;
wherein the additional hash-based placement iterations are executed based on one or more hash-values of one or more populated nodes.

74. The method according to claim 73, wherein the additional hash-based placement iterations are also based on one or more hash-values of the additional allowed hardware implementations.

75. The method according to claim 74, wherein an additional hash-based placement iteration comprises selecting an additional allowed hardware implementation of a group of additional allowed hardware implementations.

76. The method according to claim 75, wherein the selecting is based on (i) one or more hash values of members of the group and (ii) one or more hash values of one or more populated nodes that appear, at least in part, in the members of the group.

77-83. (canceled)

84. The method according to claim 75, wherein the selecting of the additional allowed hardware implementation is followed by determining whether the additional allowed hardware implementation can be placed in the window that is partially populated.

85-92. (canceled)
